(19) United States
(12) Patent Application Publication
(10) Pub. No.: US 2026/0269262 A1
(43) Pub. Date: Sep. 10, 2026

(54) SOLVENT-FREE PROCESS FOR PREPARING LITHIUM-ION BATTERIES

(71) Applicant: Cabot Corporation, Boston, MA (US)

(72) Inventors: Olha Mashtalir, N. Billerica, MA (US); YanYan Zhao, Winchester, MA (US); Peter Aurora, Lexington, MA (US); Toivo T. Kodas, Harvard, MA (US)

(21) Appl. No.: 19/164,843

(22) PCT Filed: Mar. 20, 2024
(86) PCT No.: PCT/US2024/020620

§ 371 Date: Sep. 12, 2025

Related U.S. Application Data
(60) Provisional application No. 63/491,598, filed on Mar. 22, 2023.
(60) Provisional application No. 63/583,327, filed on Sep. 18, 2023.

(51) Int. Cl. H01M 4/62; H01M 4/02; H01M 4/04; H01M 4/131; H01M 4/133; H01M 4/134; H01M 4/136; H01M 4/1391; H01M 4/1393; H01M 4/1395; H01M 4/1397; H01M 4/38; H01M 4/505; H01M 4/525; H01M 4/58; H01M 4/583; H01M 10/0525

(52) U.S. Cl. CPC H01M 4/625; H01M 4/0435; H01M 4/1391; H01M 4/1393; H01M 4/1395; H01M 4/1397; H01M 4/386; H01M 4/583; H01M 4/623; H01M 2004/021; H01M 2004/027; H01M 2004/028; H01M 4/131; H01M 4/133; H01M 4/134; H01M 4/136; H01M 4/505; H01M 4/525; H01M 4/5815; H01M 4/582; H01M 4/5825; H01M 10/0525

(57) ABSTRACT

A solvent-free process employs carbon nanotubes to prepare compositions and electrodes for lithium-ion batteries. The carbon nanotubes can be multifunctional, providing two or more desirable characteristics, acting, for example, as a conductive carbon additive, as a fibrillizing agent and/or as a mechanical reinforcement. In one example, the carbon nanotubes are provided in combination with a carbon black. In another example, an electroactive material, a fibrillizable binder, e.g., PTFE, and carbon nanotubes are combined in one or more steps. High shear mixing is used to fibrillize the binder. The resulting composition can be formed into a film which can be applied onto a suitable substrate to form an electrode.

### RELATED APPLICATIONS

This application is related to U.S. Provisional Application No. 63/491,598, filed on Mar. 22, 2023, and U.S. Provisional Application No. 63/583,327, filed on Sep. 18, 2023, both being incorporated herein by this reference in their entirety.

### GOVERNMENT SUPPORT

This invention was made with Government support under Award Number DE-EE0009109.0000, awarded by the Office of Energy Efficiency and Renewable Energy (EERE) of the U.S. Department of Energy. The Government has certain rights in the invention.

### BACKGROUND OF THE INVENTION

Lithium-ion batteries (LIBs) are commonly used sources of electrical energy for numerous applications ranging from electronic devices to electric vehicles. A lithium-ion battery typically includes a negative electrode and a positive electrode in an arrangement that allows lithium ions and electrons to move to and from the electrodes during charging and discharging. An electrolyte solution in contact with the electrodes provides a conductive medium in which the ions can move. To prevent direct reaction between the electrodes, an ion-permeable separator is used to physically and electrically isolate the electrodes. During operation, electrical contact is made to the electrodes, allowing electrons to flow through the device to provide electrical power, and lithium ions to move through the electrolyte from one electrode to the other.

Most commercially available lithium-ion batteries have anodes that contain graphite, a material capable of incorporating lithium through an intercalation mechanism. Typically, lithium is added to the graphite anode during the charging cycle and removed as the battery is used.

Cathodes typically include a conductive substrate supporting a mixture containing at least an electrochemically active material and a binder. The electroactive material, such as a lithium transition metal oxide, is capable of receiving and releasing lithium ions. As with the anode, the binder is used to provide mechanical integrity and stability to the electrode.

Since the electroactive material and the binder often display poor electrically conducting or even insulating properties, cathodes often include an additive component which enhances the electrical conductivity of the electrode. Conductive additives, carbon conductive additives, for instance, also can be found in LIB anode compositions.

To manufacture the electrode, the active electrode material, graphite for instance, is mixed with a binder, typically a polymeric or resin material. Many existing fabrication methods employ casting techniques based on wet slurries that contain not only the binder but also solvents, plasticizers, conducive additives, and so forth. During manufacturing, the slurry is coated or extruded onto a conductive substrate. Since the solvent is detrimental to the final product, it is removed by drying.

However, drying operations, in particular those aimed at solvent removal, require time, slowing down the overall production process. Also, they can raise costs as well as environmental concerns. In terms of the end product, the removal of the solvent during the drying process often leads to migration of the binder to the surface of the electrode. Though minimal migration can be acceptable in some cases, it is problematic in others. For high loadings (thick, >4.5 mAh/g) electrodes, for instance, the migration is exacerbated, leading to delamination and poor electrode performance.

As a result, “dry” alternatives, aiming at reducing or eliminating the drying step associated with slurry techniques, are being developed. While dry processes also produce electrodes that typically contain an electroactive material, binder and a conductive additive component, they do not require using a solvent.

Dry approaches that have been proposed include high shear mixing involving fibrillizable binder, use of sacrificial binder removed upon processing of the electrode, dry powder spraying, electrostatic spray deposition, cold plasma deposition, sputtering deposition, powder printing, to name a few. In some, a fibrillization promoter is incorporated into the binder and the resulting formulation is subjected to high shear mixing to fibrillate the binder, thereby generating a web-like structure that can better hold the materials together and support the active material.

To date, the most common additive used to promote binder fibrillization has been activated carbon (AC). Generally, AC is derived from carbonaceous source materials such as bamboo, coconut husk, willow peat, wood, coir, lignite, coal, and petroleum pitch. Activation is achieved by physical or chemical approaches, as known in the art. For many applications, AC powders are milled to tens of micron (μm) particle dimensions prior to activation.

### SUMMARY OF THE INVENTION

While dry manufacturing processes have the potential of eliminating many of the challenges posed by the addition and/or removal of solvents (often harmful), problems remain.

For example, current “dry” fabrication techniques utilize not only the active electrode material but many other ingredients such as fibrillization promoters, conductive additives and binders. Since many of these components are not involved in the electrochemical reactions that generate electrical energy, they can negatively affect certain performance characteristics (e.g., capacity and energy density) of the battery, as they effectively lower the amount of active material that can be contained in a given volume.

State of the art fibrillization agents such as ACs often contain high impurity levels. Also, high surface areas and surface oxygen-containing groups that are typical for ACs tend to promote significant water uptake. These features can contribute to irreversible capacity losses, diminishing battery performance. Furthermore, ACs fail to add sufficient conductivity, raising the need for increased amounts of conductive additives in the overall formulation. Even as a simple fibrillization promoter, AC often requires relatively high loadings (5 to 10 weight %, in many cases) and this, in and of itself, also limits the amount of active materials that can be included.

A need exists, therefore, for compositions and processes that address at least some of the problems associated with existing approaches.

In general, the invention relates to the use of carbon nanotubes (CNT or CNTs plural) to bring about needed improvements in the fabrication method, product electrode and/or assembled battery. More specifically, the invention relates to the use of CNTs in the context of dry or solvent-free electrode manufacturing processes.

It was discovered that, when used in such processes, CNTs can function as a binder processing agent. In fact, the carbon nanotubes can have a multifunctional character, providing two or more desirable features. For example, the carbon nanotubes can act as a fibrillizing aid, serving as an AC substitute; as conductive carbon additive (by forming electrically conductive networks); and/or as a mechanical reinforcement, adding mechanical strength and flexibility to a product film/electrode.

It was further discovered that certain combinations of CNTs and carbon black (CB) can effectively process a binder in the solvent-free approach described herein. In many cases, CNTs-CB combinations can further impart desirable mechanical properties and/or electrical conductivity to the resulting dry processed film and/or electrode. Cathodes prepared using CNTs and CB, for example, can display short- and long-range electrical conductivity combined with good Li diffusion.

Thus, in some embodiments, the dry process described herein is conducted using a combination of CNTs and CB (e.g., a blend) which includes one or more types of CNTs and one or more types of CB. At least one of the CB employed can have multifunctional properties (acting, in one illustration, as conductive additive, binder processing aid and mechanical reinforcement).

Typically, the method described herein is conducted without using any liquid (a solvent, for instance). Ingredients are provided as loose particulate materials such as flowing or pourable powders, flakes, beads, granules, pellets and so forth.

However, it is possible, in some cases, to use small amounts of liquid (solvent, for instance) to carry out the method described herein, typically a step other than the fibrillating or binder processing step. Generally, if liquid is being added, amounts employed are no greater than about 10 wt % of the total weight amount of ingredients used. In many situations, liquid, e.g., solvent, is added in an amount that is no greater than 1 wt %.

One aspect of the invention features a method for preparing an electrode composition. The method includes combining an active electrode material, a binder and CNTs, and processing the binder in the presence of the CNTs. Many embodiments of this method are conducted without liquid (typically a solvent) addition. The CNTs can be a constituent in a CNTs-CB carbon additive component.

In general, the binder can be any semi-crystalline polymer. Accordingly, the method can be conducted with binders conventionally thought of as “fibrillizable” as well as with those conventionally considered as “non-fibrillizable” binders; combinations thereof also can be utilized.

In one illustration, a method for preparing an electrode composition comprises: combining an active electrode material, a fibrillizable binder and CNTs, and subjecting the binder to a fibrillization operation in the presence of the CNTs or, in some cases, in the presence of a combination or blend or CNTs and one or more CB(s).

Another aspect of the invention features a method for preparing an electrode composition. The method comprises processing a binder (subjecting the binder to high shear conditions, for example) in the presence of CNTs, and adding an electrode active material before, during or after binder processing. The binder can be a fibrillizable binder, a non-fibrillizable binder or any combination thereof. The CNTs can be provided in a CNTs-CB component.

In specific embodiments, the method described herein is conducted without adding any fibrillating aid other than the CNTs or the CNTs-CB component. In such a case, the CNTs (or the CNTs-CB blend) provide the entire binder processing (e.g., fibrillating) functionality, completely replacing conventional fibrillating agents such as activated carbons, for instance. It is also possible to use CNTs (or the CNTs-CB component) in combination with various amounts of a conventional fibrillizing aid, an activated carbon, for example.

The electroactive material, the binder, e.g., a fibrillizable binder, and the CNTs (or CNTs/CB blend) can be combined in a single step, the binder processing, a fibrillization operation, for instance, being conducted subsequently. In other embodiments, the constituents are combined sequentially. For example, the binder, in the presence of the multifunctional additive, is processed, e.g., fibrillized, first, this step being followed by mixing with the electroactive material. Other sequences are possible.

Uniform distributions of constituents can be obtained using conditions other (often milder) than those utilized in the binder processing, e.g., fibrillization. Low shear mixing techniques also can prevent particle fragmentations and preserve particle size.

The electrode composition prepared as described herein can yield a free-standing film, or a film laminated to a substrate. Thus, in embodiments, the electrode composition, typically a loose particulate material such as a flowing powder, containing electroactive material, processed (e.g., fibrillated) binder, CNTs, and optional CB is further processed. In one example, the composition is formed into a free-standing film that can be applied to an electrically conductive substrate or support to form an electrode. For instance, the composition can be calendered and laminated to a conductive foil substate. The calendering operation can be conducted at or above room temperature, e.g., at a temperature similar or close to the polymer glass transition temperature. The lamination step can be performed during or after the composition is calendered. The resulting product electrode can be assembled into a LIB battery in which one or both electrodes is/are prepared by a solvent-free process. In one example, both electrodes are prepared according to techniques described herein.

In a further aspect, the invention features a dry processed film which includes an active electrode material; a binder, typically processed, e.g., fibrillized; and CNTs. In some cases, the dry processed film further includes at least one CB (which can be multifunctional). Before any drying operation, the dry processed film has a weight that is the same as or within 1 wt % of its theoretical weight.

Using CNTs can bring about a number of attractive properties to a dry processed electrode film and/or electrode, including, for example, electrical conductivity, attractive physical properties, e.g., good tensile strength, thermal stability (sometimes comparable to that of diamond crystals or in-plane graphite sheets) and/or chemical stability, to name a few.

The CNTs can reduce the amount of binder and/or conventional processing additives required in the fabrication process, increasing the potential loading with active materials and leading to higher energy density electrodes and therefore batteries. Approaches described herein can reduce or eliminate the need for ACs. In many cases, smaller additive amounts are needed, increasing the available content allowed for active electrode materials, yielding batteries with higher energy densities and longer lifetimes. The CNTs can improve binder fibrillization and material distribution across the electrode. Enhanced adhesion and mechanical stability represent yet other potential benefits. Dry-processed electrodes prepared using CNTs are expected to exhibit good charge transfer. The reduction in electrode impedance with a CNT additive can improve cell rate capacity and charging performance, opening opportunities for thicker electrodes and higher energy density batteries with fast charging capabilities.

In some cases, the initial CNTs may be broken or separated into smaller units during processing. It is believed that such fragments, distributed, e.g., uniformly, throughout an electrode composition, can lead to electrodes with improved mechanical properties and/or electrical connectivity (by forming enhanced electrical pathways) in the resulting electrode.

Further improvements are possible with combinations of CNTs and one or more carbon blacks. Certain combinations of CNTs and CBs, for instance, have multifunctional properties and can deform a binder to a degree sufficient to process ingredients in a solvent-free approach. They can further impart desirable mechanical properties. With respect to electrical characteristics, it is believed that CNTs, together with CB, can advantageously combine and balance the long-range conductivity but limited Lit diffusion of CNTs with the short-range conductivity but good Li+diffusion of CBs.

Whereas binder migration phenomena are often observed with slurry-prepared electrodes, the process and composition described herein appear to yield uniform distributions across the electrode. The fibrillated binder keeps the electroactive particles (along with the conductive additives) together (cohesion), while also keeping the electrode film layer attached to the metal substrate (adhesion).

The solvent-free techniques described herein reduce or eliminate the use of harmful solvents such as N-methyl-2-pyrrolidone (NMP) and the like. Being able to bypass the drying step associated with slurry (or other “wet” processes) can simplify, speed up manufacture, and reduce the footprint of the electrode production line. These benefits, as well as reducing or eliminating the need for solvent recycling or emissions abatement measures can contribute to overall cost reductions.

The above and other features of the invention including various details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1A includes bar charts comparing the tensile strength (bottom) and elastic modulus (top) of dry cathode films prepared with: various types of CNTs; a CB; and an AC, as references;

FIG. 1B is a bar chart comparing the in-plane resistivity of dry cathodes prepared using various CNTs and the in-plane resistivity of a reference dry cathode, prepared with a CB;

FIG. 2A illustrates the impact of D₅₀ of CNTs on tensile strength (bottom) and elastic modulus (top) of dry cathode films;

FIG. 2B is a bar chart showing the in-plane electrode resistivity measured for a dry cathode prepared with pulverized (pre-milled) and non-pulverized (not pre-milled) CNTs;

FIG. 3 presents cross-sectional SEM images of dry cathode films prepared with non-pulverized CNTs (A and C) and pulverized CNTs (B and D). The left-hand images of FIGS. A and B are backscattering electron images (A-I and B-I); the right-hand images are second-electron images (A-II and B-II);

FIG. 4 presents cross-sectional SEM image (A) and corresponding EDS elemental mappings of Fluorine (B) and Carbon (C) for a dry cathode film prepared with pulverized CNTs (scale bar 100 μm);

FIG. 5A presents a comparison of tensile strength (bottom) and elastic modulus (top) of dry cathode films prepared using pulverized and non-pulverized CNTs at two different loadings;

FIG. 5B is a bar chart of in-plane resistivity of dry cathodes prepared with pulverized and non-pulverized CNTs at two different loadings;

FIG. 6 compares in-plane (top) and through-plane (bottom) electrode resistivity of dry cathodes prepared with several CNTs;

FIG. 7A compares the tensile strength of dry cathode films prepared with selected CB only, CNT only, and CB/CNT blends at two different ratios;

FIG. 7B compares the tensile strength of dry cathode films prepared with selected CB only, CNT only, and CB/CNT blends at two different ratios;

FIG. 8 compares the cathode resistivity of dry electrodes prepared with CB only, CNT only, and CB/CNTs blends at selected ratios;

FIG. 9 compares the clastic modulus of dry cathode films prepared with blends of CB with CNTs at two different loadings and CB only at the two different loadings;

FIG. 10A is a bar chart of the tensile strength of dry cathode films formed with CB/CNTs blends at selected ratios, with CNT only and CB only as comparative examples, and with an AC for reference; cathode films that could not be made are marked as X on the chart;

FIG. 10B compares the tensile strength of dry cathode films prepared with two different types of CNTs in combination with the same CB, using the same CB and CNTs loadings.

FIG. 11 compares the tensile strength of a dry anode film prepared with three different types of CNTs and with an AC as a reference.

FIG. 12 is a plot showing C/20, C/10, C/5, C/3, C/2, 1C, 2C discharge capacity of full coin cells with dry cathodes prepared using pulverized and non-pulverized CNTs.

FIG. 13 is a plot showing the discharge capacity cycling of full coin cells with dry cathodes prepared using pulverized and non-pulverized CNTs.

FIG. 14 is a plot showing C/20, C/10, C/5, C/3, C/2, 1C, 2C discharge capacity of full coin cells with dry cathodes prepared using several CNTs with similar D₅₀.

FIG. 15 is a plot showing the discharge capacity cycling of full coin cells with dry cathodes prepared using several CNTs with similar D₅₀.

FIG. 16 is a plot showing the discharge capacity at 2C of full coin cells with dry cathodes using the same CNTs at two different active material loadings and densities.

FIG. 17 is a plot showing C/20, C/10, C/5, C/3, C/2, 1C discharge capacity of full coin cells with dry cathodes prepared using selected CB only, and CB/CNT blends at two different ratios.

FIG. 18 is a plot showing the discharge capacity cycling of full coin cells with dry cathodes prepared using selected CNT only and a CB/CNT blend.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Also, all conjunctions used are to be understood in the most inclusive sense possible. Thus, the word “or” should be understood as having the definition of a logical “or” rather than that of a logical “exclusive or” unless the context clearly necessitates otherwise. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The invention generally relates to the manufacture of electrodes for electrochemical cells, in many cases for batteries such as, for instance, LIBs. In one example, the batteries of interest are rechargeable LIBs.

Typically, LIB batteries are named according to the acronyms for the electroactive material employed to form the cathode, often an intercalation compound. Embodiments described herein can be practiced with or adapted to various types of lithium-ion batteries currently known in the art, such as, for example, LCO (lithium cobalt oxide), LMO (lithium manganese oxide), NCM (lithium nickel cobalt manganese oxide), NCA (lithium nickel cobalt aluminum oxide), LCP (lithium cobalt phosphate), LFP (lithium iron phosphate), LFMP (lithium iron manganese phosphate), LFSF (lithium iron fluorosulfate), LTS (lithium titanium sulfide) batteries, or other LIBs currently known or developed in the future.

Many electrode manufacturing techniques for use in an electrochemical cell include the formation of an electrode composition (anode or cathode) that can be applied (coated, extruded, laminated, etc.) onto a conductive substrate. In the composition, the active electrode material is mixed (blended) with a binder (e.g., polymers, resins, etc.), which serves to associate and hold together the active materials. Liquids used to dissolve or carry the binder material, plasticizers and/or other additives often are included.

Generally, in a conventional solvent-based process, the polymer binder and other components are mixed with a suitable liquid to form a slurry that can then be applied onto the substrate. Typical liquid amounts employed are at least about 40% based on the total weight of the ingredients used; many wet processes require higher solvent amounts. As the solvent is removed (e.g., during drying), the binder becomes increasingly sticky and adheres to the particles present and/or the substrate.

In contrast to slurry-based techniques, embodiments described herein involve a “solvent-free” also referred to as a “dry” process. In this solvent-free approach, some and typically all constituents (e.g., active material, binder, additives, etc.) needed to prepare the electrode composition are provided as loose particulate materials, e.g., free flowing powders, flakes, pellets, beads, and so forth. Implementations described herein can include one or more operations designed to mix these constituents (using, for instance, equipment designed to blend loose particulate materials) as well as at least one operation designed to process the binder. Subjecting the binder to certain shear conditions, for example, can result in binder deformations, e.g., binder elongations, formation of binder strands, entanglements, and so forth. With some types of binders, this is referred to as binder “fibrillization”. Typically, the resulting composition is a loose particulate material.

In many aspects of the invention, ingredients are combined, and the binder is processed, e.g., fibrillized, without adding any liquid, e.g., solvent.

While most embodiments involve a process that is conducted without liquid addition and is completely solvent free, small amounts of liquid, e.g., solvent, can be used in some cases, to moisten, for instance, at least some of the particles being mixed. This may occur when forming a pre-blend that is then completely dried prior to conducting subsequent operations. In one example, any solvent used to form such as pre-blend is removed, e.g., by drying, before the binder is deformed. Processing (e.g., fibrillizing) the binder is then conducted with loose, free flowing or pourable particles, under entirely solvent-free conditions.

While ingredients can be mixed and the binder processed (e.g., fibrillized) under entirely solvent-free conditions, solvent can be used in some cases in a post operation (an operation that takes place after the dry electrode composition has been formed) such as, for example, during film fabrication or electrode lamination, to facilitate film processibility, for example. Processes that involve solvent use during a post operation also are referred to herein as “dry” or “solvent-free”. Generally, any solvent employed (to spray the film during film fabrication of lamination, for instance) is removed, e.g., by drying, as the electrode is passed through heated calender rolls.

Suitable solvents can be selected from solvents typically encountered in LIB production and include but are not limited to N-methylpyrrolidone (NMP), acetone, alcohols, and water. If used, the solvent can be removed by standard drying techniques. It is expected that such low solvent levels can be removed completely or nearly so.

If used, the amount of solvent is no greater than about and often less than about 1 weight % of the entire product electrode composition (a composition containing electroactive material, processed, e.g., fibrillized, binder and other ingredients, an additive component, for instance). In illustrative examples, the amount of solvent employed is within a range of from about 0 to at most 1 wt %, such as from about 0 to about 0.2, to about 0.4, to about 0.6, to about 0.8 wt %; or from about 0.2, to about 0.4, to about 0.6, to about 0.8, to about 1 wt %; or from about 0.2 to about 0.4, to about 0.6, to about 0.8, to about 1 wt %; or from about 0.4 to about 0.6, to about 0.8, to about 1 wt %; or from about 0.6 to about 0.8, to about 1.0 wt %; or from about 0.8 to about 1 wt %, based on the total weight of ingredients being used.

In other situations, solvent can be added in amounts within a range of from about 0 to about 10 wt %, such as within a range of form about 0 to about 2, to about 4, to about 6 to about 8 wt %; or from about 2 to about 4, to about 6, to about 8, to about 10 wt %; or from about 4 to about 6, to about 8 to about 10 wt %; or from about 6 to about 8, to about 10 wt %; or from about 8 to about 10 wt %.

Finished products, e.g., films or films laminated onto a current collector, prepared by the solvent-free or dry process described herein, can be recognized by the absence of detectable processing solvents or processing solvent residues. In contrast to these “dry” products, products obtained by wet (slurry) techniques will typically include detectable processing solvents and/or processing solvent residues. In a different approach, dry electrodes or films prepared according to embodiments of the invention are expected to display a uniform or substantially uniform binder distribution across the electrode or film thickness; in general, less uniformity is observed with wet techniques, which often lead to binder migrations towards a film surface.

As for the constituents employed, the solvent-free process described herein involves: an electroactive component (a material or combination of materials that participates in the electrochemical charge/discharge reactions of an electrochemical cell such as by absorbing or desorbing lithium); a binder, which can be a fibrillizable or a non-fibrillizable binder; and carbon nanotubes. In some embodiments, the carbon nanotubes are a constituent in a carbon additive component. In further embodiments, this component also contains carbon black (CB).

For many LIB anodes, the electroactive material (also simply referred to herein as “active material” or “AM”) is graphite, e.g., natural graphite, artificial graphite (e.g., massive artificial graphite (MAG)) or blends of both. Mesocarbon microbead (MCMB), mesophase-pitch-based carbon fiber (MCF), vapor grown carbon fibre (VGCF) also can be employed. Other anode materials that can be used in addition to or alternatively to graphite include lithium titanate, tin oxide, silicon (Si) and SiOₓ (with x typically being 1.04, 1.06, etc.). In illustrative examples the anode includes graphite and/or a silicon-containing compound.

Principles described herein also can be used with other active anode materials such as, for instance, those known or currently explored, or those to be developed in the future.

The amount of the active anode material can vary, depending on the particular type of energy storage device. In illustrative examples, the amount of active anode material (graphite, for instance) is at least 80% by weight, e.g., at least 85, at least 90, at least 95, or at least 99 wt %, relative to the total weight of the (dry) electrode composition. The anode active material, e.g., graphite, can be provided in an amount of from about 80 to about: 85, 90, 93, 96, 99 wt %; or from about 85 to about: 90, 93, 96, 99 wt %; or from about 90 to about: 93, 96, 99 wt %; or from about 93 to about: 96, 99 wt %; or from about 96 to about 99 wt %.

LIBs cathodes can employ LCO (lithium cobalt oxide), LMO (lithium manganese oxide), NCM (lithium nickel cobalt manganese oxide), NCA (lithium nickel cobalt aluminum oxide), LCP (lithium cobalt phosphate), LFP (lithium iron phosphate), LFMP (lithium iron manganese phosphate), LFSF (lithium iron fluorosulfate), LTS (lithium titanium sulfide), to name a few. Materials such as these are generally referred to herein as “lithium transition metal compounds”, e.g., “lithium transition metal oxides”. In addition to cathode materials based on intercalation chemistry, e.g., typically involving chemical reactions that transfer a single electron, other types of cathode materials (having lithium ions inserted into FeF₃, for instance) can transfer multiple electrons through more complex reaction mechanisms, called conversion reactions. Other active cathode materials known in the art or developed in the future can be employed.

In some embodiments, the dry process described herein utilizes NCM or NCA cathode compositions. NCM (also referred to as “NMC”) and NCA are generally known to those skilled in the art.

In more detail, NCM can be represented by the formula Li₁₊ₓ(Ni_{y}Co_{1-y-z}Mn_{z})₁₋ₓO₂, wherein x ranges from 0 to 1, y ranges from 0 to 1 (e.g., 0.3-0.8), and z ranges from 0 to 1 (e.g., 0.1-0.3). Examples of NCMs include Li₁₊ₓ(Ni_{0.33}Co_{0.33}Mn_{0.33})₁₋ₓO₂, Li₁₊ₓ(Ni_{0.4}Co_{0.3}Mn_{0.3})₁₋ₓO₂, Li₁₊ₓ(Ni_{0.4}Co_{0.2}Mn_{0.4})₁₋ₓO₂, Li₁₊ₓ(Ni_{0.4}Co_{0.1}Mn_{0.5})₁₋ₓO₂, Li₁₊ₓ(Ni_{0.5}Co_{0.1}Mn_{0.4})₁₋ₓO₂, Li₁₊ₓ(Ni_{0.5}Co_{0.3}Mn_{0.2})₁₋ₓO₂, Li₁₊ₓ(Ni_{0.5}Co_{0.2}Mn_{0.3})₁₋ₓO₂, Li₁₊ₓ(Ni_{0.6}Co_{0.2}Mn_{0.2})₁₋ₓO₂, Li₁₊ₓ(Ni_{0.8}Co_{0.1}Mn_{0.1})₁₋ₓO₂ and Li1+x(Ni0.9C0.05Mn0.05)₁₋ₓO₂.

NCA can be represented by the formula Li₁₊ₓ(Ni_{y}Co_{1-y-z}Al₂)₁₋ₓO₂, wherein x ranges from 0 to 1, y ranges from 0 to 1, and z ranges from 0 to 1. An example of an NCA is Li₁₊ₓ(Ni_{0.8}Co_{0.15}Al_{0.05})₁₋ₓO₂.

The amount of electroactive cathode material employed can vary, depending on the particular type of energy storage device. In illustrative examples, the amount of NCM or NCA is at least 90% by weight, e.g., at least 93%, at least 96, at least 98, or at least 99% by weight, relative to the total weight of the (dry) electrode composition. NCM or NCA can be provided in an amount of from about 90 to about: 93, 96, 99 wt %; or from about 93 to about: 96, 99 wt %; or from about 96 to about 99 wt %.

In addition to the active material, the dry process described herein employs a binder. In general, the binder can be any semi-crystalline polymer.

In some embodiments, the binder is a fibrillizable binder. The fibrillizable binder can be provided in a binder component that consists of, consists essentially of, or comprises the fibrillizable binder.

Under certain processing conditions, e.g., high shear mixing in the presence of a fibrillizing agent, a fibrillizable binder is capable of producing fibrils, forming a network that can connect and support other particles present in the formulation. In more detail, it is believed that fibrillization of the binder generates a matrix, lattice, or web of fibrils (also referred to as “strands”, “ribbons”, “strings”) that imparts mechanical structure to the electrode. In a product electrode, a fibrillized binder can be detected in SEM images which will show the presence of fibrils wrapped around at least a portion of at least some of the particles present, e.g., active material particles. Other indirect techniques that can be employed to evaluate a relative degree of binder fibrillization include, for instance, energy-dispersive X-ray spectroscopy (EDX), powder rheology, tensile strength. EDX, for instance, maps fluorine element distribution throughout the dry electrode to evaluate the effectiveness of binder fibrillization. Powder rheology measures the cohesive interaction between the particles in the free-flowing electrode powder mix, while tensile strength testing measures strength of the free-standing electrode film, both being representative of the degree of binder fibrillization. In some cases, poor or no fibrillization can be inferred for dry product electrode films that crumble or peel away from a substrate.

In some implementations the fibrillizable binder is a fibrillizable fluoropolymer, such as, for instance, polytetrafluoroethylene or PTFE. Other binders that can be considered fibrillizable include but are not limited to ultra-high molecular weight polypropylene, polyethylene, and co-polymers and any combination thereof.

The fibrillizable binder (alone or as a constituent in a binder component (e.g., in a polymer blend)) can be provided in an amount of about 1 to about 10% by weight, e.g., about 1-2, 2-3, 3-4, 4-5, 5-6, 6-7, 7-8, 8-9, 9-10 wt %. In one example, the fibrillizable binder is provided in an amount of about 5 wt %. In other examples the fibrillizable binder is provided in an amount within a range of from about 1 to: about 2, about 3, about 4, about 5, about 6, about 7, about 8, about 9 wt %; or from about 2 to: about 3, about 4, about 5, about 6, about 7, about 8, about 9, about 10 wt %; or from about 3 to: about 4, about 5, about 6, about 7, about 8, about 9, about 10 wt %; or from about 4 to: about 5, about 6, about 7, about 8, about 9, about 10 wt %; or from about 5 to: about 6, about 7, about 8, about 9, about 10; or from about 6 to: about 7, about 8, about 9, about 10 wt %; or from about 7 to: about 8, about 9, about 10 wt %; or from about 8 to: about 9, about 10 wt %.

Not all situations, however, will employ a binder that is fibrillizable. Thus, some embodiments of the invention employ a binder component that consists of, consists essentially of, or comprises one or more non-fibrillizable binders. As used herein, the term “non-fibrillizable” binder refers to a binder that is difficult to fibrillize at the same conditions that are sufficient to fibrillate a “fibrillizable” binder. Nevertheless, even without reaching full fibrillization, practicing aspects of the invention (at the same or substantially the same processing conditions used for a fibrillizable counterpart) can still deform, e.g., stretch out, elongate, entangle, etc. a non-fibrillizable binder, often to a significant extent.

Without wishing to be bound by a particular interpretation or mechanism, it is believed that fibrillization may be thought of as an extreme phenomenon, where the binder polymer (which may start out as a colloidal particle) becomes stretched out very thinly, forming very long (high aspect ratio) strands that can bridge across more than two electroactive particles, thereby holding them together. Practicing embodiments described herein also can lead to stretching (elongating) and/or entangling a non fibrillizable binder, forming composites of the binder and a carbon additive, for example, or a coating onto carbon additive particles. Even if not fully fibrillated, such a “processed” non-fibrillizable binder can still serve as a glue, connecting, binding, and providing connectivity for the electroactive particles and adhesion to the current collector. Deformations of a non-fibrillizable binder can be observed by at least some of the techniques noted above.

In one example, the non-fibrillizable binder is a fluoropolymer such as polyvinylidene fluoride (PVDF). Other examples of binders that can be considered non-fibrillizable include poly(vinyldifluoroethylene-co-hexafluoropropylene) (PVDF-HFP), polyimides, and water-soluble binders, such as poly(ethylene) oxide, polyvinyl-alcohol (PVA), polyvinyl pyrrolidone (PVP), polyvinyl acetate, polyethylene-co-vinyl acetate, some polyolefins, cellulose, cellulose derivatives, to name a few. Other possible non-fibrillizable binders include polyethylene and polypropylene other than ultra-high molecular weight, ethylene-propylene-diene terpolymer (EPDM), sulfonated EPDM, styrene-butadiene rubber (SBR), hydrogenated nitrile butadiene rubber (HNBR), fluoro rubber, copolymers and/or mixtures thereof. In one example, the non-fibrillizable binder is a cellulose ester, a cellulose ether, cellulose nitrate, a carboxyalkylcellulose, a cellulose salt and a cellulose salt derivative. In some embodiments, the microparticulate non-fibrillizable binder is selected from at least one of cellulose, cellulose acetate, methylcellulose, ethylcellulose, hydroxylpropylcellulose (HPC), hydroxyethylcellulose (HEC), cellulose nitrate, carboxymethylcellulose (CMC), carboxyethylcellulose, carboxypropylcellulose, carboxyisopropylcellulose, sodium cellulose, sodium cellulose nitrate, and sodium carboxyalkylcellulose. Other examples employ combinations of a non-fibrillizable binder, PVDF, for instance, and non-fibrillizable binder, PTFE, for instance.

Non-fibrillizable binders can be present in the electrode composition in the same amounts as those used for fibrillizable binders. Other suitable amounts can be employed, as determined by routine experimentation, for example.

Fibrillizable binders in combination with non-fibrillizable binders also can be employed.

Electrode compositions routinely include ingredients such as conductive additives (e.g., conductive carbon additives or CCA), plasticizers and so forth. In the case of solvent-free processes, common techniques also call for a binder fibrillizing (also known as “fibrillating”) agent or aid, typically AC.

It was discovered that conventional fibrillizing additives (AC, for example) can be supplemented and often entirely replaced by carbon nanotubes. In many instances, the CNTs can provide multiple benefits (a feature referred to herein as “multifunctional”), serving, for instance, as binder fibrillating (or, in some cases, binder deforming) agents, as conductive additives (generating conductive networks, e.g., the long-range conductivity of the electrode), and as mechanical strengthening aids (imparting mechanical support, stability and/or flexibility to the electrode product, often the coating, layer or film typically applied onto the conductive substrate to form a battery electrode). It was further discovered that multiple benefits can be realized by supplementing or entirely replacing conventional fibrillating agents (AC, for example) by CNTs in combination with at least one type of carbon black (CB or CBs plural). In some cases, electrodes prepared by a dry process that employs a blend (mixture) of CNTs and CB outperform similarly prepared electrodes that utilize only CNTs or only CB.

As known in the art, carbon nanotubes are carbonaceous materials, typically hydrophobic, characterized by at least one sheet of sp²-hybridized carbon atoms bonded to each other to form a honey-comb lattice that forms a cylindrical or tubular structure. The carbon atoms in a carbon nanotube are arranged in a hollow (e.g., cylindrical) structure, having a length that generally is greater than the radial diameter.

CNTs may have different morphologies, including single-walled carbon nanotubes (SWCNTs) or multi-walled carbon nanotubes (MWCNTs). SWCNTs can be thought of as an allotrope of sp²-hybridized carbon similar to fullerenes. The structure is a cylindrical tube including six-membered carbon rings. Double walled carbon nanotubes (DWCNTs) tend to have properties similar to SWCNTs. Analogous MWCNTs, on the other hand, have several tubes in concentric cylinders. The number of these concentric walls may vary, e.g., from 2 to 25 or more. Typically, the diameter of MWNTs may be 10 nm or more, in comparison to 0.7 to 2.0 nm for typical SWCNTs.

Based on chirality, CNTs are classified into armchair, zigzag and chiral nanotubes.

CNTs can provide excellent electrical and thermal conductivity, and good mechanical properties. With their great conductivity, carbon nanotubes are increasingly adopted as a conductive additive in lithium-ion battery electrodes. They can enhance the battery performances such as power, cycle life and energy density.

Both single and multiple walled CNTs can be used, as can mixtures of two or more different types of CNTs. In many embodiments, the CNTs are MWCNTs. The number of walls present if MWCNTs are employed, determined, for example, by transmission electron microscopy (TEM), at a magnification sufficient for analyzing the number of wall in a particular case, can be within the range of from about 2 to about 30, for example: 4 to 30; 6 to 30; 8 to 30; 10 to 30; 12 to 30; 14 to 30; 16 to 30; 18 to 30; 20 to 30; 22 to 30; 24 to 30; 26 to 30; 28 to 30; or 2 to 28; 4 to 28; 6 to 28; 8 to 28; 10 to 28; 12 to 28; 14 to 28; 16 to 28; 18 to 28; 20 to 28; 22 to 28; 24 to 28; 26 to 28; or 2 to 26; 4 to 26; 6 to 26; 8 to 26; 10 to 26; 12 to 26; 14 to 26; 16 to 26; 18 to 26; 20 to 26; 22 to 26; 24 to 26; or 2 to 24; 4 to 24; 6 to 24; 8 to 24; 10 to 24; 12 to 24; 14 to 24; 16 to 24; 18 to 24; 20 to 24; 22 to 24; or 2 to 22; 4 to 22; 6 to 22; 8 to 22; 10 to 22; 12 to 22; 14 to 22; 16 to 22; 18 to 22; 20 to 22; or 2 to 20; 4 to 20; 6 to 20, 8 to 20; 10 to 20; 12 to 20; 14 to 20; 16 to 20; 18 to 20; or 2 to 18; 4 to 18; 6 to 18; 8 to 18; 10 to 18; 12 to 18; 14 to 18; 16 to 18; or 2 to 16; 4 to 16; 6 to 16; 8 to 16; 10 to 16; 12 to 16; 14 to 16; or 2 to 14; 4 to 14; 6 to 14; 8 to 14; 10 to 14; 12 to 14; or 2 to 12; 4 to 12; 6 to 12; 8 to 12; 10 to 12; or 2 to 10; 4 to 10; 6 to 10; 8 to 10; or 2 to 8; 4 to 8; 6 to 8; or 2 to 6; 4-6; or 2 to 4.

In many implementations, the CNTs employed are conventional (also referred to as “ordinary”, “pristine” or “fresh”) CNTs, which often are provided in individualized form, as manufactured commercially, or, in some cases, as custom-synthesized or processed.

Generally, CNTs are known to contain fair amounts of catalyst and support residuals. These species can be detected by techniques such as SEM, TEM, inductively coupled plasma atomic emission spectroscopy or ICP-AES, etc.

The CNTs can have a diameter of 100 nanometers (nm) or less, such as, for example, within the range of from about 1 to about 100 nm, e.g., within the range of from about 5 to about: 10, 20, 30, 40, 50, 60, 70, 80, 90, 100 nm; or from about 10 to about: 20, 30, 40, 50, 60, 70, 80, 90, 100 nm; or form about 20 to about: 30, 40, 50, 60, 70, 80, 90, 100 nm; or from about 30 to about: 40, 50, 60, 70, 80, 90, 100 nm; or from about 40 to about: 50, 60, 70, 80, 90, 100 nm; or from about 50 to about: 60, 70, 80, 90, 10 nm; or from about 60 to about: 70, 80, 90, 100 nm; of from about 70 to about: 80, 90, 100 nm; or from about 80 to about 90, 100 nm; or from about 90 to about 100 nm.

Specific embodiments employ CNTs having a diameter within a range from about 2 nm to about 50 nm, determined by TEM. For instance, the CNTs employed can have a diameter within a range of from about 2 to about: 5, 10, 20, 30, 40 nm; or from about 5 to about: 10, 20, 30, 40, 50 nm; or from about 20 to about: 30, 40, 50 nm; or from about 30 to about: 40, 50 nm; or from about 40 to about 50 nm.

CNTs can vary in length from about 10 nanometers (nm) to about 750 microns (μm), or higher. Thus, the CNTs can be from 10 nm to 100 nm, from 10 nm to 500 nm; from 10 nm to 750 nm; from 10 nm to 1 micron; from 10 nm to 1.25 micron; from 10 nm to 1.5 micron; from 10 nm to 1.75 micron; from 10 nm to 2 micron; or from 100 nm to 500 nm, from 100 nm to 750 nm; from 100 nm to 1 micron; from 100 to 1.25 micron; from 100 to 1.5 micron; from 100 to 1.75 micron from 100 to 2 microns; from 500 nm to 750 nm; from 500 nm to 1 micron; from 500 nm to 1 micron; from 500 nm to 1.25 micron; from 500 nm to 1.5 micron; from 500 nm to 1.75 micron; from 500 nm to 2 micron; from 750 nm to 1 micron; from 750 nm to 1.25 micron; from 750 nm to 1.5 micron; from 750 nm to 1.75 microns; from 750 nm to 2 microns; from 1 micron to 1.25 micron; from 1.0 micron to 1.5 micron; from 1 micron to 1.75 micron; from 1 micron to 2 microns; or from 1.25 micron to 1.5 micron; from 1.25 micron to 1.75 micron; from 1 micron to 2 microns; or from 1.5 to 1.75 micron; from 1.5 to 2 micron; or from 1.75 to 2 microns.

In some cases, the CNTs employed in the dry process described herein have an average length within a range of from about 1 microns to about 30 microns, such as within a range of from about 1 to about 5, from about 1 to about 10, from about 1 to about 15, from about 1 to about 20, from about 1 to about 25 microns; or from about 5 to about 10, from about 5 to about 15, from about 5 to about 20, from about 5 to about 25, from about 5 to about 30 microns; or from about 10 to about 15, from about 10 to about 20, from about 10 to about 25, from about 10 to about 30 microns; or from about 15 to about 20, from about 15 to about 25, from about 15 to about 30 microns; or from about 20 to about 25, from about 20 to about 30 microns; or from about 25 to about 30 microns.

In some embodiments, at least one of the CNTs has a length that is equal to or greater than 2 microns, as determined by SEM. In specific embodiments, more than one, e.g., a portion such as a fraction of at least about 0.1%, at least about 1%, at least about 10%, at least about 15%, at least about 20%, at least about 25%, at least about 30%, at least about 35%, at least about 40%, at least about 45%, at least about 50% or even more than one half, of the CNTs, as determined by SEM, can have a length greater than 2 microns, e.g., within ranges specified above.

The morphology of CNTs will often be characterized by a high aspect ratio, with lengths typically more than 100 times the diameter, and in certain cases much higher.

CNTs also can be characterized by their surface area. Small-diameter single-wall CNTs, for example, can have specific surface areas up to approximately 3000 m²/g, such as, for instance, up to about 1315 m²/g, while large-diameter multi-wall CNTs often are characterized by specific surface areas of up to about 1000 m²/g.

In many of the embodiments described herein, the CNTs employed have a Brunauer-Emmett-Teller (BET) surface area, measured, for example, according to ASTM D₆₅₅₆-10, that is less than about 500 m²/g, such as, for example, less than or equal to 400 m²/g; or less than or equal to 300 m²/g.

In some implementations, the BET surface area of the CNTs is within a range from about 80 to about 500, e.g., within a range of from 200 to about 500 m²/g. In specific examples, the CNTs have a BET surface area within a range from about 80 to about: 100, 150, 200, 250, 300, 350, 400, 450, 500 m²/g; or from about 100 to about: 150, 200, 250, 300, 350, 400, 450, 500 m²/g; or from about 150 to about: 200, 250, 300, 350, 400, 450, 500 m²/g; or from about 200 to about: 250, 300, 350, 400, 450, 500 m²/g; or from about 250 to about: 300, 350, 400, 450, 500 m²/g; or from about 300 to about: 350, 400, 450, 500 m²/g; or from about 350 to about: 400, 450, 500 m²/g; or from about 400 to about: 450, 500 m²/g; or from about 450 to about 500 m²/g.

In one example, the CNTs have a BET surface area from about 80 to about 110, from about 80 to about 200, from about 80 to about 230, from about 80 to about 260, from about 80 to about 280, from about 80 to about 310, from about 80 to about 350 m²/g; or from about 110 to about 200, from about 110 to about 230, from about 110 to about 260, from about 110 to about 280, from about 110 to about 310, from about 110 to about 350 m²/g; or from about 230 to about 260, from about 230 to about 280, from about 230 to about 310, from about 230 to about 350 m²/g; or from about 260 to about 280, from about 260 to about 310, from about 260 to about 350 m²/g; or from about 280 to about 310, from about 280 to about 350 m²/g; or from about 310 to about 350 m²/g.

The CNTs employed have a bulk density, calculated, for example, as a weight of CNT powder, free-fallen and untapped in the cylinder, divided by volume that the powder occupies, that can be within a range of from about 0.01 to about 0.3, e.g., from about 0.01 to about 0.2. In one illustration, the CNTs have a bulk density of about 0.03 g/cm³. Further consolidation, compacting or densification, measured by tapped density, can raise the bulk density to a range between about 0.03 g/cm³ to about 0.5 g/cm³.

The CNTs used herein can be identified and/or characterized by various techniques. Electron microscopy, including techniques such as transmission electron microscopy (TEM) and scanning electron microscopy (SEM), for example, can provide information about features such as the frequency of specific number of walls present, tube diameter, length, branching, the presence of catalyst particles, etc.

Raman spectroscopy is often used to characterize the state of carbon in the carbonaceous materials. For example, a D-band (around 1350 cm⁻¹) is associated with sp³-carbon, whereas a G band (around 1580 cm⁻¹) is associated with the sp²-carbon in the graphite or CNTs. A G′ band (around 2700 cm⁻¹) is expected to occur at about 2× the frequency of the D band. In some cases, it may be possible to discriminate between the CNTs employed to practice the invention and other carbon structures by thermogravimetric analysis (TGA).

Other CNT properties to be considered in multifunctional CNT candidates relate to their physical form. The CNT particle size, for example, is a property that can be determined by particle size distribution (PSD) techniques and/or scanning electrode microscopy (SEM). A particle size analyzer can be used to measure the intensity of scattered light by laser diffraction to conduct particle size measurement. As a laser beam is directed through a dispersed particulate sample, large particles will scatter light at small angles, while small particles will scatter the light at a larger angle. Average particle size (D₅₀) is the particle size range based on 50% in the particle size distribution of the dispersion.

Due to strong van der Waals interactions, e.g., along their length, CNTs can easily form aggregates such as bundles, ropes or agglomerates. CNTs may occur as substantially parallel “forests”, in randomly tangled masses (“pillows”) of structured agglomerations, or other kinds of aggregates.

In some implementations, aggregates are tailored to have sufficient strength to fibrillate the binder, yet fall apart to some extent, generating smaller fragments that can be spread throughout the composition, yielding a uniform CNT distribution.

In many embodiments, the CNT-material has a 97% or higher CNT purity. Typically, anionic, cationic or metal impurities are low, e.g., in the parts per million (ppm) range. Often, the CNTs employed herein require no further additives to counteract Van der Waals' forces.

Commercially, examples of CNT materials that can be utilized include but are not limited to those available from Cabot Corporation under the tradename of ENERMAX® carbon nanotubes, from CNano under FT trade name, LG Chem under Lucan trade name. Some specific examples include ENERMAX 61, FT2000, Lucan BT1003M, and others.

Table 1 below presents physical properties characterizing illustrative CNTs, namely CNT1 through CNT9.

TABLE 1

| | | | Bulk | |
|---|---|---|---|---|
| | BET, | Diameter, | density, | PSD (μm) |
| CNT type | m²/g | nm | g/cm³ | D₅₀ |
| CNT 1 | 265.5 | 9~12 | 0.12 | 133~135 |
| CNT 2 | 300.41 | 5~10 | 0.092 | 60 |
| CNT 3 | 225.59 | 10~20 | 0.16 | 55 |
| CNT 4 | 101.22 | 30~50 | 0.149 | 80 |
| CNT 5 | 261.6 | 9~12 | 0.0308 | 12~16 |
| CNT 6 | 268.8 | 5~10 | 0.0189 | 15~16 |
| CNT 7 | 229.7 | 10~20 | 0.0614 | 11~15 |
| CNT 8 | 208.41 | 10~20 | 0.06 | 15 |
| CNT 9 | 91.2 | 30~50 | 0.0511 | 9~15 |

Additional processing or modifications can further enhance the multifunctional character of CNTs.

In one approach, for example, the CNT material is pre-milled (milled before mixing with the fibrillizable binder and/or electrode active material) using, for instance, a high shear mixing apparatus such as, for instance, jet mills, ball mills, extruders, homogenizers, etc. In many cases, the pre-milling operation is a dry pre-mill, conducted without a solvent, in a dry state, e.g., as a dry powder. In some situations, however, the pre-milling operation can involve a solvent. If this is the case, the solvent can be removed by heat drying, freeze drying, or vacuum. Conducted before the fibrillization step, a pre-milling operation, optionally in conjunction with a drying step (if solvent is employed), can increase the electrochemical performance and may enhance the fibrillizing potential of the CNTs. Pre-milling may also bring about positive mechanical effects in the film and/or electrode product. Without wishing to be bound to a particular interpretation, it is believed that the smaller particles can be more uniformly dispersed through the composition, thereby enhancing electrical and mechanical properties of the product (film or electrode). In Table 1 above, CNT5 is pre-milled (pulverized) version of CNT1, while CNT6, CNT7, and CNT9 are pre-milled (pulverized) versions of CNT2, CNT3, and CNT4, respectively.

In another approach, the CNTs employed entirely lack or have a reduced number of oxygen-containing surface groups. The reduction or absence of oxygen containing groups such as —OH, —O—, —COOH, etc., increases the hydrophobic character of the additive and thus increases the affinity of the additive to a hydrophobic fibrillizable binder such as PTFE. One technique for removing oxygen-containing groups from CNTs is heat treatment, which can be conducted in a vacuum oven, for example.

In addition to enhancing the hydrophobic character of the CNTs, heat treatment can also improve their electrical conductivity and reduce or minimize impurities (such as those left behind from the manufacture of the CNTs) that can interfere and negatively impact cyclic performance, hot storage and/or battery safety. Other techniques that can be employed to remove impurities, include, for instance, acid washing, a combination of heat treatment and acid washing or other techniques. In some approaches, the acid treatment includes oxidation with HNO₃, H₂SO₄, HCl, HF, alone or in any combinations thereof, or graphitization. Other possible approaches include wetting MWCNTs with dimethyl formamide (DMF), oxidized first, then suspended in nitric acid.) In Table 1 above, CNT7 is the acid washed version of CNT8.

CNTs can be doped (with boron, for example), graphene-winged or otherwise treated.

CNTs may undergo more than one process and/or modification. For example, CNTs may be both heat-treated and pre-milled.

Thus, in general, the solvent-free process described herein can employ a CNT additive without any further processing or modification (e.g., not comminuted (e.g., not pulverized), not heat-treated, not acid-washed, etc.), as pulverized (pre-milled) powders, as modified, e.g., heat treated CNTs, acid washed CNTs, and so forth. TEM, X-ray tomography or other techniques could be used to determine the type of CNTs employed, in some cases. Good multifunctional properties often are reflected in the quality of the film, electrode or battery product obtained.

CNTs may form or be compounded to form mixtures of CNTs with various combinations and distributions of the above characteristics (number of walls, diameters, lengths, morphologies, orientations, etc.).

In some embodiments, one or more types of CNTs are employed in combination with one or more types of carbon black (CB).

As known, CBs are materials that exist in the form of aggregates, which, in turn, are formed of CB primary particles. In most cases, primary particles do not exist independently of the CB aggregate. While the primary particles can have a mean primary particle diameter within the range of from about 10 nanometers (nm) to about 50 nm, e.g., from about 10 nm to about 15 nm; from about 10 nm to about 20 nm; from about 10 nm to about 25 nm; from about 10 nm to about 30 nm; or from about 10 nm to about 40 nm, the aggregates can be considerably larger. CB aggregates have fractal geometries and are often referred to in the art as CB “particles” (not to be confused with the “primary particles” discussed above).

Many types of CB are produced in a furnace-type reactor by pyrolyzing a hydrocarbon feedstock (FS) with hot combustion gases to produce combustion products containing particulate CB. Characteristics of a given CB often depend upon the conditions of manufacture and may be altered or modified, e.g., by changes in temperature, pressure, FS, residence time, quench temperature, throughput, and other parameters.

As known in the art, CBs can be described by certain properties determined according to procedures, often standardized protocols, well known in the art. For instance, CBs can be characterized by their Brunauer-Emmett-Teller (BET) surface area, measured, for example, according to ASTM D6556-10; by their oil adsorption number (OAN), determined, for instance, according to ASTM D 2414-16; by their statistical thickness surface areas (STSAs), a property that can be determined by ASTM D 6556-10.

For a given CB, it may also be of interest, in some cases, to specify the ratio of its STSA to its BET surface area (STSA:BET ratio).

Crystalline domains of CBs can be characterized by an Lₐ crystallite size, as determined by Raman spectroscopy. Lₐ is defined as 43.5×(area of G band/area of D band). The crystallite size can give an indication of the degree of graphitization, where a higher Lₐ value correlates with a higher degree of graphitization. Raman measurements of Lₐ were based on Gruber et al., “Raman studies of heat-treated carbon blacks,” Carbon Vol. 32 (7), pp. 1377-1382, 1994, which is incorporated herein by reference. The Raman spectrum of carbon includes two major “resonance” bands at about 1340 cm⁻¹ and 1580 cm⁻¹, denoted as the “D” and “G” bands, respectively. It is generally considered that the D band is attributed to disordered sp² carbon, and the G band to graphitic or “ordered’ sp² carbon. Using an empirical approach, the ratio of the G/D bands and an Lₐ measured by X-ray diffraction (XRD) are highly correlated, and regression analysis gives the empirical relationship:

$${L}_{a} = 43.5 \times ( area of G band / area of D band ) ,$$

in which Lₐ is calculated in Angstroms. Thus, a higher Lₐ value corresponds to a more ordered crystalline structure.

The crystalline domains can be characterized by a Le crystallite size. The L_{c} crystallite size was determined by X-ray diffraction using an X-ray diffractometer (PANalytical X'Pert Pro, PANalytical B.V.), with a copper tube, tube voltage of 45 kV, and a tube current of 40 mA. A sample of carbon black particles was packed into a sample holder (an accessory of the diffractometer), and measurement was performed over angle (2θ) range of 10° to 80°, at a speed of 0.14°/min. Peak positions and full width at half maximum values were calculated by means of the software of the diffractometer. For measuring-angle calibration, lanthanum hexaboride (LaB₆) was used as an X-ray standard. From the measurements obtained, the L_{c} crystallite size was determined using the Scherrer equation: Le (Å)=K*λ/(β*cos θ), where K is the shape factor constant (0.9); λ is the wavelength of the characteristic X-ray line of Cu K_{α1} (1.54056 Å); β is the peak width at half maximum in radians; and θ is determined by taking half of the measuring angle peak position (2θ).

Surface cleanliness can be described by the surface energy (SEP) of the CB, a property that can be determined by Dynamic Vapor (Water) Sorption (DVS) or water spreading pressure (described, for instance in U.S. Pat. No. 10,886,535 B2, issued on Jan. 5, 2021, to Korchev et al. and incorporated herein by this reference.

Other techniques that can be used to study CBs include Fourier transform infrared (FTIR) spectroscopy, thermogravimetric analysis (TGA), X-ray photoelectron spectroscopy (XPS), scanning electron microscopy (SEM), and transmission electron microscopy (TEM). FTIR spectroscopy is particularly useful for determining the nature of surface functional groups, while SEM/TEM techniques help to visualize the size and morphology of the particles. XPS is often used to determine the elemental composition of a material and TGA can provide information on the decomposition and oxidation characteristics of carbons.

Various CBs have been and continue to be developed for carbon conductive additive (CCA) applications. Attractive electroconductivity often combines a high specific surface and extensively developed structure (the arrangement of primary CB particles within an aggregate) and porosity. CBs that can be added to anode and/or cathodes compositions for LIBs prepared by a slurry process are described, for instance, in International Publication Nos. WO 2020/197670, to Cabot Corp., published on Oct. 1, 2020 and WO 2020/197673, to Cabot Corp., published on Oct. 1, 2020. Both are incorporated herein by this reference in their entirety.

Examples of commercially available CBs that can be effective CCAs include LITX® 50, LITX® 66, LITX® 200, LITX® 300, LITX® HP, and LITX® MAX 90 carbon black particles available from Cabot Corporation; C-NERGY™ C45, C-NERGY™ C65 and SUPER P® products from Imerys; Li-400, Li-250, Li-100 and Li-435 products from Denka; and the EC300 and EC600 product from Ketjen. The physical properties of illustrative CBs that can be employed as CCAs are presented as samples CB1 through CB5 in Table 2 below.

TABLE 2

| | | | | | | | | | Pore | | |
|---|---|---|---|---|---|---|---|---|---|---|---|
| | | | | | | (IG/ | | Pore | volume | Pore | |
| | | | | | | (IG + | | volume | (cm³/g) by | volume | Total |
| | BET | | | | La | ID)) | Lc | (cm³/g) by | BJH (pore | (cm³/g) by | Pore |
| CB | SA, | STSA, | OAN, | SEP, | Raman, | % Cr | XRD, | BJH (pore | size 2 nm- | BJH (pore | Volume |
| type | m²/g | m²/g | mL/100 g | mJ/m² | Å | Raman | Å | size <2 nm) | 50 nm) | size >50 nm) | (cm³/g) |
| CB1 | 999 | | 265 | 6.7 | 25.5 | 37 | | 0.015 | 0.66 | 1.54 | 2.21 |
| CB2 | 1430 | 1415 | 605 | 2.5 | 20.9 | 32.4 | 12.8 | | 1.47 | 0.4 | 2.22 |
| CB3 | 1491 | 507 | | 12.5 | | | | 0.028 | 0.49 | 0.64 | 1.15 |
| CB4 | 100 | 100 | 231 | 2.6 | 27.1 | 39.6 | 20.1 | 0.003 | 0.15 | 0.21 | 0.36 |
| CB5 | 131 | 97 | 230 | 28 | 13 | 23 | | NA | 0.1 | 0.15 | 0.26 |

The carbon blacks employed in combination with the CNTs can have selected morphologies and/or surface chemistries and can provide two or more functions in the context of dry (solvent-free) electrode fabrication methods. In general, a “multifunctional” carbon black (CB) can be defined as a CB that effectively deforms or fibrillizes a binder employed in a solvent-free process; contributes to the electronic/ionic conductivity of the electrode; and/or provides mechanical benefits. In specific implementations, a multifunctional CB can be thought of as being capable of fibrillizing a fibrillizable binder at a loading no greater than 5 weight percent (wt %). At this loading, the multifunctional CB also acts as a carbon conductive additive, reducing the in-plane resistivity of the electrode. In many cases, mechanical benefits are obtained as well.

Multifunctional CBs are described, for example, in International Patent Application No. PCT/US23/64614, filed on Mar. 17, 2023 and published as WO2023/183754 A1 on Sep. 28, 2023), with the title Solvent-Free Process for Preparing Lithium-Ion Batteries, which is incorporated herein by this reference.

Further to displaying the electroconductivity desired for LIB applications, other properties that can contribute to the multifunctionality of a CB involve one, more, or all of the following: surface roughness; surface chemistry (surface energy); particle strength; and particle size.

Typically, the CB surface roughness is related to the porosity of the particles, described, for instance, by a pore volume or pore size distribution. RMS surface roughness (calculated as the Root Mean Square of a surface's measured microscopic peaks and valleys), for example, is known to correlate with surface pore size (e.g., similar order of magnitude). For instance, 2 nm pores can be indicative of an approximate RMS surface roughness of 1 nm.

Broadly, CB porosity can fall into one or more of the following categories: microporosity, defined by pores having diameter less than 2 nm; mesoporosity, defined by pores of a diameter ranging from 2 to 50 nm; and macroporosity, defined by pores having a diameter larger than 50 nm. Mean pore diameters and pore volumes can be determined in accordance with the techniques described in E. P. Barrett, L. G. Joyner, P. P. Halenda, J. Am. Chem. Soc. 1951, 73, 373-380 (BJH method).

In more detail, pore size distribution and pore volume in a carbon black can be determined by gas physisorption techniques such as nitrogen adsorption porosimetry, by measuring nitrogen gas adsorption using BET analysis followed by fitting the adsorption isotherms with different models, for example, the DFT (density function theory) and the BJH (Barrett-Joyner-Halenda) model, depending on the pore size region of interest. The BJH adsorption model technique was relied upon to fit the N₂ adsorption isotherm and calculate the mesopore and macropore volumes presented herein.

Without wishing to be bound by a particular interpretation, it is believed that fibrillizing properties in multifunctional CBs are driven, at least in part, by the macroporosity of the particle, with macropores acting as anchoring points for interlocking the binder on the CB surface and stretching the binder into fibrils when high shear forces are applied.

While some carbon blacks are predominantly microporous materials, techniques exist for increasing porosity levels and/or producing CBs with tailored porosity types.

Contacting a CB starting material with an oxidant stream, for instance, can enhance porosity, in particular the mesoporous character of the CB product. Increasing the porosity of furnace blacks can be achieved by lengthening the residence time in the carbon black reactor, allowing the tail gas additional time to attack and etch the carbon surface. Another method relies on the addition of alkali earth metal ions to the carbon black feedstock, as these ions are known to catalyze the etching of the carbon black via the tail gas. Both techniques involve etching the CB “in-situ,” i.e., in the furnace reactor during production, to create carbon blacks with internal porosity. Some approaches that can be employed to modify carbon blacks are described, for instance, in U.S. Pat. No. 8,895,142 B2, to Kyrlidis et al. and U.S. Pat. No. 10,087,330 B2, to Green et al., both being incorporated herein by this reference. Commercially, modified carbon blacks that can be utilized are available from Cabot Corporation. The properties of two illustrative CB specifications, namely samples CB2 and CB3, are presented in Table 2, above. CB2 is the steam-etched version of CB5.

Fibrillizing properties also were found to depend on the surface chemistry or surface activity, a function that is often related to the manufacturing and/or heating process employed in preparing a particular CB. In many cases, surface chemistry or surface activity is associated with oxygen-containing groups found on the CB surface. In some embodiments, good fibrillating CB candidates lack or are depleted in oxygen-containing surface groups, tending to be less hydrophilic (more hydrophobic).

For example, it is believed that effective fibrillization is driven, at least in part, by the affinity (adhesion) of CB to the binder, e.g., a fibrillizable binder. Thus, in one implementation, the preferred multifunctional CBs for successfully fibrillizing a binder such as PTFE are hydrophobic CBs (namely CBs that lack oxygen-containing surface groups) and/or low surface energy CBs. Oxygen content can be measured by inert gas fusion. Low surface chemistry CBs have oxygen content within a range of from about 10 ppm to about 5000 ppm, e.g., from about 100 ppm to about 1000 ppm.

The presence of oxygen-containing surface groups can be reduced or minimized by techniques such as heat treatment, or other surface modification approaches, as known in the art or as developed in the future. Surface-modified, e.g., heat-treated CBs, can be compared to and distinguished from regular carbon blacks by X-ray scattering, Raman spectroscopy, surface energy measurements by gas adsorption, or other techniques, as known in the art. In some cases, heat-treated and other surface-modified CBs also tend to display a reduced moisture uptake during processing. In Table 2, CB1 is a heat-treated version of CB3, while CB4 is a heat-treated version of CB5.

Other CB properties to be considered in multifunctional CB candidates relate to their physical form. The CB particle size, for example, is a property that can be determined by particle size distribution (PSD) techniques and/or scanning electrode microscopy (SEM).

Also believed to play a role in the multifunctional character of the selected CB relates to the CB particle strength (displayed as particle hardness and/or particle cohesion). Particle strength allows the CB to effectively stretch the polymer binder; this along with particle roughness are important mechanical properties to achieve desirable binder fibrilization. Particle strength can be measured by individual pellet crash test, oscillatory viscoelastic measurements, or other techniques, as known in the art.

CBs can be provided as any number of loose particulate materials. Truly fluffy CB-containing powders, for example, have been found to perform particularly well in some of the dry processes tested. Such powdery materials can be characterized by their particle size, BET, and/or other properties. In many cases, powders employed have a density no greater than about 100 g/cm³.

Less fluffy CB particles, in the form of jet-milled pellets, for instance, can also be employed. Powder CBs can be pelletized using techniques and equipment known in the art. In one example, CB is pelletized with an emulsion solution of the binder utilized to form the electrode composition described herein. Other approaches employ an emulsion solution of a different binder, for instance, a binder that belongs to the same chemical family or has similar functionally active groups that can bind or otherwise interact with the binder employed to carry out the dry process. It is thought that, as a result, the energetics interaction of the pelletized CB with the binder used to prepare the electrode composition increases, Pellet sizes, which apply to pure CB and CB-polymer composites, can be within a range of from about 0.1 mm to about 5 mm.

Granules of carbon black also may be useful in some situations. In many cases, CB granules are a densified form of CB, without polymer being present in the final product. Generally, CB granules can be formed via a conventional pelletization process associated with CB production. It is also possible to form CB granules by dispersing fluffy CB in water, followed by spray drying. Granular CB also can be provided as a composite such as a binder-encapsulated granule or as a masterbatch.

In some embodiments, the granules employed change their form and/or function during processing. Thus, an initial CB granular material can be relied upon to process, e.g., fibrillate, a polymer binder. Size comminution occurring during this operation can release smaller CB units. In the presence of an electroactive material, the fragmentation of the granules may enhance the distribution of the smaller CB units throughout the electrode composition, resulting in electrode films with improved electrical conductivity and/or mechanical strength.

The surface roughness and/or surface energy of the granules often is controlled by choosing the particles composing the granules. For instance, the surface roughness can be selected based on the surface texture created by the primary particles and/or aggregates that compose the secondary granule. Such a surface is rough on a dimensional scale where roughness is provided by nano/micro scale of hills and valleys on the surface of the CB granule.

A multifunctional CB in granular shapes can have a particle size in the micron range, e.g., 1-10 μm, such as, for instance: 1 to 8, 1 to 6, 1 to 4, 1 to 2; or 2 to 10, 2 to 8, 2 to 6, 2 to 4; or 4 to 10, 4 to 8, 4 to 6; or 6 to 10, 6 to 8; or 8 to 10 microns. With some granules, an initial size can be reduced by grinding to various degrees to provide particles of roughly 10 microns down to below 1 micron. Some implementations utilize a combination of sizes.

The strength of the granules also can be considered. It can be minimized by forming the granule in the absence (or with minimal content) of binder during granule formation; increased strength of the granules can be achieved by using varying concentrations of binders and/or different types of binders. In some implementations, the binder employed to form the CB granules is the same or a similar binder to the binder employed in the dry process.

Some embodiments employ granules that are friable, under processing, e.g., fibrillization conditions. In such cases, the strength of the granules can be controlled so that the strength is high enough to fibrillate or deform the polymer binder and low enough for the granules to fall apart and release conducting and reinforcing carbon units, such as aggregates.

For many dry processes, the CNTs described above are employed in combination with a CB having a BET that is no greater than about 1600 m²/g and an OAN that is no greater than about 650 ml/100 g.

The CB can have a BET that is no greater than about 1600 m²/g, e.g., no greater than about: 1500, 1400, 1300, 1200, 1100, 1000, 900, 800, 700, 600, 500, 400, 300, 200, 100 or 50 m²/g. The BET can be within a range of from about 35 to about 1600, such as, for example, within a range of from about 35 to about: 100, 200, 300, 400, 500, 600, 700, 800, 900, 1000, 1100, 1200, 1300, 1400, 1500; or from about 100 to about: 200, 300, 400, 500, 600, 700, 800, 900, 1000, 1100, 1200, 1300, 1400, 1500, 1600; or from about 200 to about: 300, 400, 500, 600, 700, 800, 900, 1000, 1100, 1200, 1300, 1400, 1500, 1600; or from about 300 to about: 400, 500, 600, 700, 800, 900, 1000, 1100, 1200, 1300, 1400, 1500, 1600; or from about 400 to about: 500, 600, 700, 800, 900, 1000, 1100, 1200, 1300, 1400, 1500, 1600; or from about 500 to about: 600, 700, 800, 900, 1000, 1100, 1200, 1300, 1400, 1500, 1600; or from about 600 to about: 700, 800, 900, 1000, 1100, 1200, 1300, 1400, 1500, 1600; or from about 700 to about 800, 900, 1000, 1100, 1200, 1300, 1400, 1500, 1600; or from about 800 to about: 900, 1000, 1100, 1200, 1300, 1400, 1500, 1600; or from about 900 to about: 1000, 1100, 1200, 1300, 1400, 1500, 1600; or from about 1000 to about: 1100, 1200, 1300, 1400, 1500, 1600; or from about 1100 to about: 1200, 1300, 1400, 1500, 1600; or from about 1200 to about: 1300, 1400, 1500, 1600; or from about 1300 to about 1400, 1500, 1600; or from about 1400 to about: 1500, 1600; or from about 1500 to about 1600 m²/g.

The CB employed in the dry process described herein can have an OAN that is no greater than about 650 ml/100 g, e.g., no greater than about 500, no greater than about 400, no greater than about 300, no greater than about 250, no greater than about 200, no greater than about 150, no greater than about 120 ml/100 g. The multifunctional CB can have an OAN within the range of from about 120 to about 650 ml/100 g, e.g., from about 120 to about 200, to about 300, to about 400, to about 500 ml/100 g, to about 600, to about 650 ml/100 g; or from about 200 to about 300, to about 400, to about 500, to about 600, to about 650 ml/100 g; or from about 300 to about 400, to about 500, to about 600, to about 650 ml/100 g; or from about 400 to about 500, or to about 600, to about 650 ml/100 g; or from about 500 to about 600, to about 650 ml/100 g; or from about 600 to about 650 ml/100 g.

LIB anodes, containing graphite, for example, can be prepared by a dry process in which CNTs are used in combination with a CB having a BET that is no greater than about 1600 m²/g, such as no greater than about 1200, no greater than about 1000, no greater than about 700, no greater than about 500, no greater than about 200, no greater than about 100, or no greater than about 35 m²/g. The BET can be within a range from about 35 to about 1600 m²/g. For instance, the BET can be within a range of from about 35 to about 50, to about 75, to about 100, to about 150, to about 200; or from about 50 to about 75, to about 100, to about 150, to about 200; or from about 75 to about 100, to about 150, to about 200; or from about 100 to about 150, to about 200; or from about 150 to about 200 m²/g. In one example, the selected CB has a BET within a range from about 50 to about 200 m²/g.

For anode applications, the CB used in combination with CNTs can have an OAN that is no greater than about 650 ml/100 g, e.g., no greater than about 500, no greater than about 400, no greater than about 300, no greater than about 240, no greater than about 200, no greater than about 150, no greater than about 120 ml/100 g. In one implementation, the CB selected for preparing an LIB anode by a dry process has an OAN within a range of from about 120 to about 650 ml/100 g, such as within a range of from about 120 to about 150, to about 200, to about 240, to about 300 ml/100 g; or from about 150 to about 200, to about 240, to about 300 ml/100 g; or from about 200 to about 240, to about 300 ml/100 g; or from about 240 to about 300 ml/100 g. In one example, the selected CB has an OAN within a range of from about 130 to about 240 ml/100 g.

LIB cathodes, employing, for instance, a lithium transition metal compound, can be prepared by a dry process that utilizes CNTs in combination with a CB having a BET that is at least about 80 m²/g, such as at least about: 100, 200, 300, 400, 500, 600, 700, 800, 900, 1000, 1100, 1200, 1300, 1400, 1500, up to about 1600 m²/g. The BET can be within a range of from about 500 to about 1600 m²/g, such as within a range of from about 500 to about: 600, 700, 800, 900, 1000, 1100, 1200, 1300, 1400, 1500 m²/g; or from about 600 to about: 700, 800, 900, 1000, 1100, 1200, 1300, 1400, 1500, 1600 m²/g; or from about 700 to about: 800, 900, 1000, 1100, 1200, 1300, 1400, 1500, 1600 m²/g; or from about 800 to about: 900, 1000, 1100, 1200, 1300, 1400, 1500, 1600 m²/g; or from about 900 to about: 1000, 1100, 1200, 1300, 1400, 1500, 1600 m²/g; or from about 1000 to about 1100, 1200, 1300, 1400, 1500, 1600 m²/g; or from about 1100 to about: 1200, 1300, 1400, 1500, 1600 m²/g; or from about 1200 to about 1300, 1400, 1500, 1600 m²/g; or from about 1300 to about: 1400, 1500, 1600 m²/g; or from about 1400 to about: 1500, 1600 m²/g; or from about 1500 to about 1600 m²/g. In one example, the selected CB has a BET within a range of from about 1350 to about 1600 m²/g. In another example, the selected CB has a BET within a range of from about 50 to about 190, such as within a range of from about 90 to about 100 m²/g. In a further example, the CB has a BET between 500 and 650 m²/g.

For cathode applications, the CB used in combination with CNTs can have an OAN no greater than about 650 ml/100 g, e.g., no greater than about 600, no greater than about 500, no greater than about 500, no greater than about 400, no greater than about 300, no greater than about 250, no greater than about 200, down to about 120 ml/100 g. The CB can have an OAN within the range of from 120 to about 250, to about 350, to about 450, to about 550, to about 650; or from about 250 to about 350, to about 450, to about 550, to about 650; or from about 350, to about 450, to about 550, to about 650; or from about 450 to about 550, to about 650 ml/100 g; or from about 550 to about 650 ml/100 g. In one example, the selected CB has an OAN within a range from about 180 to about 650 ml/100 g. In another example, the CB has an OAN within a range of about 250 to about 650 ml/100 g.

In many cases, CBs that can be used to prepare LIB cathodes by the dry process described herein have a BET within a range of from about 80 to about 1600 m²/g and an OAN within a range of from about 120 to about 650 ml/100 g. An illustrative CB that can be used to prepare a LIB cathode has a relatively high BET surface area (e.g., within a range of from about 1350 to about 1600 m²/g), coupled with a relatively low OAN (e.g., within a range of from about 120 to about 220 ml/100 g). Another illustrative CB that can be used to prepare a LIB cathode has a BET surface area within a range of from about 80 to about 200 m²/g and an OAN within a range of from about 140 to about 280 m²/g, such as about 240 or lower, within a range of from about 140 to about 180 ml/100 g, for example. A further illustrative CB has a BET within a range of from about 500 to about 1600 m²/g and an OAN within a range of from about 180 to about 650 ml/100 g. Yet another illustrative CB that can be used to prepare a LIB cathode has a BET surface area below 650 m²/g (e.g., within a range of from about 500 to about 650 m²/g) and an OAN within a range of from about 180 to about 260 ml/100 g.

In many cases, CBs that can be used to prepare LIB anodes by the dry process described herein have a BET within a range of from about 35 to about 1600 m²/g and an OAN within a range of from about 120 to about 650 ml/100 g. An illustrative CB that can be used to prepare a LIB anode has a relatively low BET surface area (e.g., within a range of from about 50 to about 200 m²/g) coupled with an OAN within a range of from about 130 to about 240 ml/100 g.

Further to the BET and OAN properties mentioned above, many CBs that can be utilized are characterized by one or more of the following: a surface energy of about 15 mJ/m² or less, a Raman microcrystalline planar size (Lₐ) of at least about 17 Å, a mesopore volume of at least about 0.1 cm³/g, a macropore volume of at least about 0.2 cm³/g, and a total mesopore and macropore volume of at least about 1 cm³/g.

In more detail, the CB can have a surface energy (SEP) of less than or equal to 15 mJ/m², for example, from about 1 to about 10 mJ/m², such as from about 1 to: about 3, about 5, about 7, about 9 mJ/m²; or from about 3 to: about 5, about 7, about 9, about 10 mJ/m²; or from about 5 to: about 7, about 9, about 10 mJ/m²; or from about 7 to: about 9, about 10 mJ/m²; or from about 9 to about 10 mJ/m².

In many implementations, the CB has an Lₐ crystallite size of at least 17 Å, for example, from 17 Å to 50 Å. For instance, the CB can have an Lₐ crystallite size of from about 17 Å to: about 20, about 30, about 40 Å; or from about 20 Å to about 30, to about 40, to about 50 Å; or from about 30 Å to: about 40, about 50 Å; or from about 40 to about 50 Å.

With respect to the porosity, the CB can have a mesopore volume of at least 0.1 cm³/g, e.g., at least 0.35 cm³/g, e.g., from about 0.35 to about 2 cm³/g, and a total mesopore and macropore volume of at least 0.2, cm³/g, e.g., from about 0.2 to about 3 cm³/g.

In some implementations, the mesopore volume is from about 0.35 to: about 0.5, about 1, about 1.5; of from about 0.5 to: about 1, about 1.5 cm³/g, about 2; or from about 1 to: about 1.5, about 2; or from about 1.5 to about 2 cm³/g. In other implementations, the mesopore volume is within a range of from about 0.1 to about 0.25 cm³/g.

Some CBs that can be used for preparing cathode compositions by the dry process described herein have a macroporosity of at least 0.2, e.g., at least 0.4 cm³/g. In the case of anode compositions, some suitable CBs will have a macroporosity of at least 0.1, e.g., within a range of from about at least 0.1 to about 0.4 cm³/g.

Total mesopore and macropore volumes characterizing CBs that can be employed to prepare an electrode composition by a solvent-free process can be at least 0.2 cm³/g, typically higher. In one example, a CB used to prepare an anode composition has a total mesopore and macropore volume within a range of from about 0.2 to about 0.8 cm³/g. In the case of cathodes, the CB can have a total mesoporosity and macroporosity that is at least 1 cm³/g.

In some examples, the multifunctional CB has a % crystallinity of at least 22%, for example, from 23% to 50%, such as within a range of from about 23 to about: 30, 35, 40, 45%; or from about 30 to about: 35, 40, 45, 50%; or from about 35 to about: 40, 45, 50%; or from about 40 to about: 45, 50%; of from about 45 to about 50%.

In one illustration, the CB is selected to combine sufficient surface area (measured by BET N₂ adsorption, for example) for best binder processing, e.g., fibrillization, while ensuring that the particular CB agglomerates employed (e.g., CB pellets or jet mill CB particles) can break down into particles small enough, e.g., less than 2 microns (μm), to maximize surface interactions between CB particle and the binder and thus effectively process, e.g., fibrillize, the binder.

More than one type of CB can be employed along with the CNTs constituent. In some implementations, a multifunctional CB is provided along with a second CB (which may or may not be multifunctional), in a CB blend, for example. One example utilizes at least two carbon blacks having one or more characteristics that are different from one another, e.g., with respect to their BET. Also possible are blends of carbon blacks with structure-OAN that are different from each other and/or blends of different carbon morphology, i.e., activated carbon or graphite with one or more CBs. In specific examples, at least one component in the blend is a multifunctional CB.

Examples of suitable CB materials that can be utilized include commercially available specifications such as: Vulcan® series CB such as Vulcan® XCmax 22, a Black Pearls® series CB such as Black Pearls 2000 carbon black, PBX® series CB such as PBX 51, LITX® series CB such as LITX HP, LITX MAX 90 from Cabot Corporation

Ratios of the CNT constituent to the CB constituent can be within a range of from about 99:1 to about 1:99, such as within a range of from about 10:90 to about 60:40.

In many cases, the solvent-free process described herein is conducted in the absence of any fibrillating aids other than the CNTs or a combination of CNTs and CB. A further fibrillizing agent, AC for instance, can be added in some situations. As used herein, the term “fibrillizing aid” or “fibrillizing agent” is a material that is other than the binder or active electrode material and that promotes fibrillization of a fibrillizable binder. “Additional”, “further”, or “other” aid, additive, agent, etc. refers to a material other than (i.e., a material that excludes or is not) the CNT material or the CNT-CB combination described above. Typically, the additional fibrillization aid is not considered multifunctional.

Some illustrative examples employ CNTs (or a combination of CNTs and a CB, which can be multifunctional), along with another (additional) material, typically included as a discrete (separate) ingredient. Examples of such other or additional materials can include a conventional fibrillizer such as AC, a hard carbon, graphite, graphenes, other non-fibrillizing conductive additives, plasticizers, or any combination thereof. In some applications, the CNTs or a blend of CNTs with CB are combined with AC in a ratio within a range of from about 95:5 to about 50:50.

For many implementations, the ingredients described herein (CNTs, CB, AM, binder, other optional additives, etc.) are provided as loose particulate materials such as flowing or pourable powders, flakes, beads, granules, pellets and so forth.

As already noted, many aspects of the invention relate to methods for producing electrode compositions, electrode products (e.g., films), electrodes (in which an electrode product such as a film has been applied onto a conductive substrate), and/or batteries.

Turning first to the dry process employed to prepare an electrode composition, performing this process targets at least two objectives: blending some and typically all the constituents, constituents that, in most cases, are provided in the form of loose (e.g., flowing or pourable) particles; and processing the binder in the presence of CNTs (or a combination of CNTs and at least one CB, e.g., a multifunctional CB. In some embodiments, each of these two objectives is met by one or more mixing operations conducted under specific shear conditions, using suitable equipment.

A low shear mixing, for example, can be selected to distribute ingredients, as uniformly as possible, for example utilizing a roll mill. As used herein, the term “low shear mixing” refers to mixing conducted under conditions that are not sufficient or not substantially sufficient to fibrillize a fibrillizable binder. Relying on low shear mixing conditions also can avoid excessive particle fragmentations, often a consideration for some electroactive materials.

In many embodiments, processing the binder in the presence of CNTs (or a CNTs-CB combination) is conducted under high shear mixing. As used herein, the term “high shear mixing” refers to shear conditions that are vigorous enough to deform (e.g., elongate, entangle) a binder to a degree sufficient to prepare a film electrode by a solvent-free technique. In the case of fibrillizable binders, high shear mixing refers to mixing under shear conditions that are sufficient to fibrillize the binder.

Without wishing to be bound by a particular interpretation, it is believed that, in the presence of CNTs (optionally in combination with a CB, e.g., a multifunctional CB) and under high shear conditions, a binder polymer is deformed, becoming stretched out, elongated and/or entangled. Surface energy and/or the surface roughness attributes can facilitate grabbing hold of the binder polymer; the CNTs, optional CB and polymer can become squished between electroactive particles, resulting in the binder polymer being stretched out. With CNTs and, optionally, CB particles dispersed in the binder or on the surface of the binder, it is thought that these particles can hold together neighboring polymer domains. Other contributing factors include polymer-polymer interactions (which are expected to increase with increased polymer elongations and/or with multi-directional shear forces), electroactive particles-polymer binder interactions (which can relate to surface energy), and/or other factors.

At the same or substantially the same high shear conditions, these manifestations tend to become more pronounced when the binder employed is a fibrillizable binder. Surface and other properties of the CNTs (or CNTs and CB) can promote snagging the polymer here and there. With all particles moving under high shear mixing, the polymer becomes elongated, forming very long, very thin strands (having a high aspect ratio). Typically, these effects will be less pronounced with a non-fibrillizable binder processed at the same or substantially the same high shear conditions. Or, stated differently, a non-fibrillizable binder may require increased high shear conditions to obtain results approaching full fibrillization.

In addition to the processing contributions described above, CNTs or combinations of CNTs with CB can enhance electrical conductivity and, in many cases, can act as a mechanical reinforcement by holding together fibrillizable as well as non-fibrillizable polymer binders that are “deformed” (elongated, entangled, etc.) to a full or lesser extent, or “undeformed” (globular, rounded, spherical shaped, etc).

In some situations, high shear mixing also can be relied upon to break particles into smaller fragments. Larger particles of CNTs and/or CB, or granules such as pellets, for instance, can be comminuted into smaller particles that become uniformly spread throughout the electrode composition, thereby enhancing electrical conductivity and/or mechanical properties. In one example, before the CNTs have been subjected to mixing (in particular high shear mixing)), the D₅₀ particle size distribution of the initial CNTs utilized can be within a range of from about 60 to about 500 μm, for example, within the range of from about 70 to about 300, e.g., from about 100 to about 200 μm. As a result of subjecting CNTs to high shear mixing, the starting CNTs particles can break into smaller particles having, for example, a particle size within a range of from about 5 to about 100 μm, e.g., from about 10 to about 30 μm.

Specific shear values can depend on the scale of the operation, the materials involved, type of mixing equipment and/or other factors. Low or high mixing settings can be determined or optimized based on prior experience, routine experimentation, and so forth.

Constituents can be combined in any order designed to obtain a mixture, preferably a mixture that is well dispersed, e.g., with a uniform distribution of the constituents, in other words a mixture that is homogeneous. In one example, the CNTs are homogeneously dispersed on the surface of the electroactive material and the binder. If CB is employe, it can be mixed with the CNTs to form a pre-blend. In a different approach, CNTs and CB can be added individually to one or more other ingredients. This addition can be simultaneous or sequential.

Binder processing (e.g., fibrillization) can be performed on any mixture or pre-mixture (pre-blend) which brings together CNTs (optionally in combination with CB, e.g., a multifunctional CB) and the binder.

Suitable techniques that can be used or adapted to conduct the steps of mixing and/or binder processing, e.g., fibrillization, include mechanical agitation, shaking, stirring, etc., and can rely on equipment such as jet mills, tube mills, acoustic mixers, extruders, planetary mixers, other mixing devices, e.g., laboratory-scale mixers, equipment suitable for pilot-scale evaluations, for full-scale industrial manufacturing and so forth.

Stepwise sequences can employ one type of apparatus to conduct the first operation (e.g., preparing a pre-blend), and another type of apparatus in the subsequent operation (fibrillization, for instance). The same is true for shear and/or other mixing parameters.

In one embodiment, CNTs (or a combination of CNTs and CB) are first combined with the binder using high shear equipment to process, e.g., fibrillize, the binder. If employed, the CB can be added separately from the CNTs or in a pre-blend with the CNTs. In some cases, the high shear operation also breaks the multifunctional additive particles (pelletized granules or other particulates susceptible to comminution under high shear conditions) into smaller fragments. The resulting mixture is then combined with the electroactive material (graphite in one example); use of low shear conditions during this step favors preserving particle size (of the electroactive material, for example).

In another embodiment, CNTs (or CNTs and CB, added individually or in a pre-blend) are first combined with the electroactive material in a pre-mixing step conducted under low shear, for example, to obtain a uniform distribution of these constituents. The resulting mixture is combined with the binder, followed by processing, e.g., fibrillization, using high shear conditions.

In a further embodiment, the electrochemical active material, the binder and the CNTs (or a combination of CNTs and CB) are all mixed (e.g., under low shear conditions); the mixture is then subjected to high shear conditions to process, e.g., fibrillate, the binder.

Other sequences are possible. For instance, the electroactive material can be first mixed with the binder, followed by the addition of the CNTs (or CNTs and CB) and processing, e.g., fibrillization, under high shear conditions.

Low shear mixing and/or processing operation, e.g., fibrillization, can be conducted in one or more (two, three, four, five, six, etc.) mixing stages or pulses(s) that can last for a suitable period, e.g., withing a range of from about 10 seconds to about 5 minutes, e.g., within a range of from about 30 seconds to about a minute, to about 90 seconds, to about 2 minutes, to about 2.5 minutes, to about 3 minutes, to about 4 minutes, to about 5 minutes; from about 1 minute to about 90 seconds, to about 2 minutes, to about 3 minutes, to about 4 minutes, to about 5 minutes; From about 90 seconds to about 3 minutes, to about 4 minute, to about 5 minutes; from about 2 minutes to about 3 minutes, to about 4 minutes, to about 5 minutes; from about 3 minutes to about 4 minutes, to about 5 minutes; from about 4 minutes to about 5 minutes. Different time intervals also can be employed. The duration of two, more or all pulses can be the same or different.

A pulse can be followed by a rest or a cool down period. Resting periods can be at ambient, e.g., room temperature. Cooling can be to a temperature below ambient, e.g., below room temperature, often at 0° C. or below, for instance at a temperature within a range of about −5 to about 5° C.

The rest or cooling period can depend on temperatures reached during mixing, quantities handled, and so forth. In many cases, cooling will last for a few minutes, e.g., 10 minutes to half an hour or longer. Cooling periods can differ in duration and/or temperature conditions.

To illustrate, a binder-containing composition can be subjected to a high shear blending at about 25,000 RPM to about 10,000 RPM, optionally at about 18,000 RPM for half a minute, then cooled to a temperature at or below freezing, e.g., at about −10° C., for 10 minutes. A low shear mixing can be conducted at about 2,000 RPM to about 4,000 RPM, for 1 minute followed by a cool-down for 10 minutes at about 0° C.

In one example, a pre-blend of CNTs and electroactive material is prepared using an acoustic mixer, for several minutes, in one example, at 100 G force. The resulting blend is combined with the binder at fibrillization parameters, e.g., using a lab scale jet mill at the pressure rate of 100-90-90-10 psi.

In another example, all components are mixed in a tube mill (such as an IKA TubeMill 100) at 25,000 RPM in a pulsed approach in which blending is alternated with rest periods, followed by a longer duration mixing operation.

Process operations and/or conditions employed to form the electrode composition can preserve the integrity of some or all the initial CNTs used, which will remain intact. In some cases, however, an initial CNT material may be broken into smaller CNT units, generating CNT fragments, for example. Except for their reduced sizes, CNT fragments generally share the properties of intact CNTs and can be identified by electron microscopy and other techniques, as described above. Applied shear can distribute these fragments throughout the composition. Without wishing to be bound to a particular interpretation, it is believed that CNTs, as well as comminuted CNTs, distributed, e.g., uniformly, in the electrode composition, can result in electrodes with enhanced electrical conductivity and/or desirable mechanical properties.

If the CNT additive is provided in the form of CNT aggregates, bundles or ropes, these can be comminuted or separated into smaller particles under the operations and/or conditions employed to form the electrode composition. Resulting smaller particles, thinner bundles or even individual CNTs are then distributed throughout the composition, contributing to desirable mechanical and/or electrical attributes.

Mixing and/or processing, e.g., fibrillization, steps can be monitored by visual inspection, hand calendering, powder rheology, or another suitable technique. For instance, a small amount can be handled manually and sheared or passed through a hand calender. End points can be established based on experience, routine experimentation, visual inspection, and so forth. Whether these operations have been successful also can be determined by SEM, performance and/or other techniques typically conducted on the electrode product, e.g., an electrode film.

The resulting electrode composition can be in the form of pellets, powders (often fluffy powders), composites such as polymer-encapsulated granules (masterbatch) or other forms of free flowing or loose particulate materials.

In an optional step, the electrode composition can be sieved to remove unwanted clumps.

The electrode composition will typically include CNTs, optionally in combination with a CB constituent, an active electrode material, and a “processed” binder. Some product electrode compositions, in particular those prepared with a fibrillizable binder, will include a post fibrillization binder (also referred to herein as a “fibrillized binder”), often exhibiting fibrils of high aspect ratios. Compositions prepared with non fibrillizable binders will still present a binder that is “deformed” (elongated, entangled, etc.) but perhaps to a lesser extent than that observed with fibrillizable binders at the same or substantially the same fibrillization conditions. A processed, e.g., fibrillized, binder can be detected by techniques described above. Successful binder processing, e.g., fibrillization, often is reflected by the quality of the resulting electrode (electrode film, for example). In some cases, electrode compositions prepared with non fibrillizable binders will include a binder that is “undeformed” (globular, rounded, spherical shaped, etc.). Even in such cases, the CNTs (optionally in conjunction with CB) can act as a binder and mechanical reinforcement of the electrode.

Based on the total weight of the electrode composition, the multifunctional CNTs can be present in an amount within a range of from about 0.1 to about 10 wt %, e.g., from about 0.3 to about 5.0 wt %, e.g., from about 0.3 to about 3 wt %. In one implementation, for instance, the CNTs represent between 3 and 5% by weight of the product electrode composition, such as, for instance, between 3 and: 3.5, 4 or 4.5 wt %; between 3.5 and: 4, 4.5 or 5 wt %; or from 4 and: 4.5 or 5 wt %; or from 4.5 and 5 wt %. In another implementation, CNTs are present in an amount within a range of from about 0.3 to: about 0.5, about 1.0, about 1.5, about 2.0, about 2.5; or from about 0.5 to: about 1.0, about 1.5, about 2.0, about 2.5, about 3; or from about 1.0 to: about 1.5, about 2.0, about 2.5, about 3.0; or from about 1.5 to: about 2.0, about 2.5, about 3.0; or from about 2.0 to: about 2.5, about 3.0; or from about 2.5 to about 3.0. In many cases, the CNTs are provided in an amount not greater than about 5% by weight based on the total weight of the electrode composition. Specific amounts within as well as outside these ranges can be selected. The same or similar amounts can be employed with blends of CNTs with CB.

In many cases, the amount of CNTs (or a CNTs-CB combination) is equal to or, preferably, lower than the AC amount required to obtain the same or substantially the same electrode performance. In an alternative approach, reaching a performance level established with AC is expected to require lower amounts of CNTs (or CNTs-CB blends), freeing extra volume for electroactive material.

In an illustrative LIB graphite anode composition, for example, the loading of the CNTs (or that of CNTs in combination with CB) is no greater than about 5 wt % and often no greater than about 3 wt %, for example no greater than 1 wt %. In specific examples, the loading is within the rage of from about 0.1 wt % to 1.0 wt %, such as, within the range of from about 0.1 to about 0.5, or from about 0.5 to about 1 wt %. Other examples employ a loading within the range of from about 1 to about 5 wt %, e.g., a loading of at least about 4.5, 4.0, 3.5, 3.0, 2.5, 2.0 or 1.5.

In an illustrative NCM cathode composition, CNTs (or a CNTs-CB combination) are present in amounts less than or equal to about 5 wt %, e.g., no greater than about 3 wt %, for example no greater than 1 wt %. In specific examples, the loading of the multifunctional additive is within the range from about 0.1 wt % to 1.0 wt %, such as, within the range from about 0.1 to about 0.5, or from about 0.5 to about 1 wt %. Other examples employ a loading within the range of from about 1 to about 5 wt %, e.g., a loading of at least about 4.5, 4.0, 3.5, 3.0, 2.5, 2.0 or 1.5.

Relative amounts of CNTs (or a CNTs-CB combination) to the fibrillizable binder can be within a ratio of 5:1 to 0.1:10, e.g., from about 1:1 to 0.1:10, from 0.5:1 to 0.1:10; from 5:1 to 0.5:10, from 5:1 to 1:5; from 5:1 to 5:10 by weight. In specific cases, the weight ratio is 1:1.

In one embodiment, the electrode composition contains active material in an amount of from about 90 wt % to about 99 wt %, e.g., to 98.0 wt %, fibrillizable binder in an amount of from about 1 wt % to about 5 wt % and a CNTs or CNTs-CB combinations in an amount of from about 0.3 wt % to about 5 wt %.

After mixing and processing, e.g., fibrillization, the composition, optionally sieved, can be formed into a product electrode by any suitable technique known in the art or developed in the future. In one implementation, the composition is formed into a film by calendering, an operation which can be conducted at or above room temperature, e.g., at a temperature similar or close to the polymer glass transition temperature. In a typical calendering operation, the composition is subjected to heat and pressure using an extruder. The softened material is passed through calendering rolls (vertical, for instance) to prepare a product electrode sheet or film. In many embodiments, the film is free-standing (or self-standing), a property that can be described using a 150-μm thick film that stands on its own, any part of the film not being in contact with any type of support, e.g., a substrate.

A desired film thickness can be obtained by adjusting the gap between the rolls, and, in some situations, other process parameters.

The roll temperature can be, for example, from about room temperature (20° C.) to about 200° C. High roll temperatures may result in a thinner free-standing film on the first pass, whereas the opposite happens at lower temperature. Roll speed can vary. In illustrative examples, the roll speed is set from about 0.17 meters per minute (m/min) to about 1.3 m/min. A slower roll speed tends to produce a thinner free-standing film on the first pass compared to a faster roll speed. The hydraulic pressure employed can be within a range of from about 1,000 psi to about 7,000. Again, a higher pressure may result in a thinner free-standing film on the first pass compared to the thicker films obtained at a lower pressure.

Additional passes through the roll mill may be employed, reducing the film thickness until the desired thickness and loading are reached. In specific implementations, the film thickness is within a range of form about 50 μm to about 300 μm, e.g., from about 50 to about 200 μm, from about 100 μm to about 150 μm. Also possible are film thicknesses within a range of from 50 to 100, 50 to 150, 50 to 200, 50 to 250 μm; or from 100 to 150, 100 to 200, 100 to 250, 100 to 300 μm; or from 150 to 200, 150 to 250, 150 to 300 μm; or from 200 to 250, 200 to 300 μm; or from 250 to 300 μm. Desired loadings may be about 10 mg/cm² to about 50 mg/cm².

Free-standing films prepared in the solvent-free process described herein are expected to have good mechanical properties. One mechanical evaluation technique that can be relied upon relates to tensile strength testing. For instance, an anode containing CNTs or a combination of CNTs and CB is expected to have a tensile strength of at least 100 kPa, while the tensile strength of a NCM cathode film is expected to be at least 500 kPa. In one illustrative example, the free-standing film has a tensile strength of at least 0.1 MPa and a thickness ranging from 80 μum to 500 μum. In many cases, the mechanical performance of the film was at least as good as that of a comparative film fabricated using AC.

In an optional operation, the film is thermally activated, e.g., to soften the binder and prepare the electrode product for being applied to a substrate. In the laboratory, this operation can be conducted using a hot plate, at 100° centigrade (C), for instance. Approaches for larger scale processes include temperature-controlled roll to roll calenders, convective and/or microwave driers, and so forth.

The film (typically free-standing and containing active electrode material, CNTs (or a blend of CNTs and CB) and a processed, e.g., fibrillized. binder) can be applied to a conductive substrate or support. Anode substrates that can be utilized include but are not limited to copper, nickel, titanium, stainless steel, carbonaceous materials in the form of foil, mesh, foam, etched, or coated current collectors. Cathode substrates that can be used include but are not limited to aluminum, titanium, carbonaceous materials in the form of foil, mesh, foam, etched, coated current collectors. In one embodiment, the film is laminated to a carbon-coated copper foil by calendering the two together, using, for instance a horizontal hot roller at a suitable roll temperature, roll speed and hydraulic pressure. Another example employs a carbon-coated aluminum current collector.

An electrically conductive glue (adhesive) can be employed to apply the film to the substrate, in some cases.

The roll temperature can be within the range from about 60 to about 120° C. Temperatures that are too high can increase blister formation and poor adhesion, while temperatures that are too low can hamper adhesion.

Roll speed may be from about 0.17 m/min to about 1.3 m/min, e.g., about 0.5 m/min, while the hydraulic pressure may be set from about 500 psi to about 2,000 psi. Other settings can be employed. The pressure can be optimized to be high enough to promote adhesion to the substrate without altering loading, porosity or other properties. In some implementations, lamination is performed before setting the final thickness and/or porosity of the film electrode.

The formation of the film and its application to the substrate can also be conducted in a single step. For instance, a powder electrode composition and a substrate foil can be fed together through calendering rolls under conditions suitable to produce a laminate in which the composition is pressed to film thickness and adhered to the foil. In this approach, the need to form a self-standing film is obviated.

The laminated structure can be shaped and/or sized for specific applications such as electrochemical cells, for instance, LIBs, e.g., rechargeable LIBs, and so forth.

Electrodes prepared as described herein can be incorporated into a lithium-ion battery according to methods known in the art, such as, for example, those described in “Lithium Ion Batteries Fundamentals and Applications”, by Yuping Wu, CRC press, (2015). In specific implementations, the batteries are coin types such as, for example, 2032 coin-cells, 18650 cylindrical cells, pouch cells, and others.

In an illustrative example, a LIB includes a cathode prepared by a dry process. The cathode contains CNTs (or a combination of CNTs and CB), e.g., in an amount no greater than 5 wt %, active cathode material (e.g., NCM) and a fibrillized binder. As described above, the active material and fibrillized binder can be present in the anode in an amount of at least 80 wt. % and no more than 5 wt %, respectively.

The second (opposite) electrode in the battery also can be prepared using a solvent-free process. In one implementation, both electrodes in the battery contain CNTs. One or both can further include CB, a multifunctional CB, for instance.

It is also possible to prepare the second electrode by a conventional dry process (using AC, for instance), by a slurry or by another non-dry technique.

In addition to the two electrodes, the typical LIB comprises a suitable electrolyte. Examples include, for instance, ethylene carbonate-dimethyl carbonate-ethylmethyl carbonate (EC-DMC-EMC), vinylene carbonate (VC), LiPF₆; ethylene carbonate-diethyl carbonate (EC-DEC, LiPF₆; or (EC-DMC), LiPF6. In the laboratory, a separator that absorbs electrolyte and prevents electrical contact between electrodes, while allowing diffusion of Li ions, can be a suitable glass fiber micro filter (for example, Whatman GF/A). Membrane separators made of polypropylene/polyethylene (for example, Celgard 2300) also can be used in some cases.

The composition or morphology of electrodes and/or batteries described herein can be characterized by various techniques. Examples include but are not limited to electron microscopy, e.g., TEM, SEM, X-ray tomography, Raman spectrometry, and other suitable qualitative or quantitative analytical methods. In one example, SEM data for graphite electrodes prepared by a dry process using the multifunctional additive described herein revealed the presence of ribbon-like binder fibrils, indicating effective fibrillization. The presence of clearly visible strings, combined with one or more properties such as elastic modulus, tensile strength, conductivity, etc. point to the multifunctionality of the additive.

Solvent amounts or absence thereof can be evaluated by weight testing. This involves drying the wet-casted electrode until electrode weight reaches the value theoretically calculated based on known solids loading of the slurry, or until electrode weight stabilizes and does not change for minimum of 3 min. In the case of an electrode produced entirely in the absence of solvent, the weight remains the same over the evaluation period. Or, stated differently, the weight of the just prepared electrode (before any drying operation) is the same as or within 1 wt % of the theoretical weight (i.e., the weight obtained by adding together the weight of the individual ingredients, typically in loose particulate form, provided in the process.

Another approach that could be employed to detect a solvent (e.g., NMP) relies on attenuated total reflectance-Fourier transform infrared (ATR-FTIR) spectroscopy (FTIR-ATR), in conjunction with gas chromatography (GC). In many cases, dry-processed electrode films can be distinguished from slurry-based products by very low or undetectable levels of solvent residue. A substantially uniform binder distribution, without binder migration towards a film surface, is yet another feature that often characterizes an electrode product prepared by a solvent-free process.

Flexibility properties characterizing the electrode, (its ability to resist cracking) can be measured by visual inspection upon bending a film by hand or using a Mandrel bend tester. In specific implementations, the electrode is evaluated and expected to pass a 10 mm diameter mandrel bar test without visible cracking to unaided eye. In an illustration, the electrode was found to pass a bending test using a pen of 8 mm diameter as a rod.

Electrode performance can be tested by procedures known in the art, or techniques adapted or developed. Suitable techniques include, for instance, in-plane and thru-plane electrode conductivity, electrochemical impedance spectroscopy (EIS), constant current charge-discharge rate capability, hybrid pulse power capability (HPPC), cycle life test.

In many cases, electrodes prepared by the solvent free process described herein perform at least as well and often better (as measured by in-plane resistivity, initial capacity, or first cycle efficiency, for example) relative to a comparative (also referred to herein as a “reference”) electrode containing the same amounts of active electrode material (e.g., NCM), binder, and a conventional fibrillization agent such as AC. Or, the amounts of CNTs (or a combination of CNTs and CB) required to reach the performance obtained with AC will typically be lower for electrodes fabricated according to embodiments described herein.

In one illustration, a dry process cathode prepared using CNTs at loadings no higher than about 1 wt %, displays at least as good a performance (measured by in-plane resistivity, rate capability, 1^{st} cycle efficiency) as a comparative (reference) electrode containing higher amounts (e.g., 5 wt %) of AC.

Electrodes prepared using the solvent-free process described herein are also expected to have good mechanical properties. Mechanical evaluation techniques that can be relied upon include peeling testing (e.g., 90°, 180°, T-peel, various fixtures), pull testing, and bending testing (mandrel experiments), to name a few. In many cases, the electrode prepared with CNTs (or with a blend of CNTs and CB) performed at least as well as a comparative electrode fabricated using AC.

Without wishing to be bound by a specific interpretation, it is believed that using CNTs, optionally in conjunction with CB, can produce ribbon-like binder strands or fibrils that can be long enough to wrap around and hold together particles of the electroactive material.

Thus, even at relatively low levels, CNTs (or a combination of CNTs and CB) appeared capable of processing, e.g., fibrillating, the binder, generating effective conductive networks in electrodes, while also contributing to desirable mechanical properties.

Electrode compositions and methods described herein also can be used (e.g., incorporated) and/or adapted to the manufacture of other energy storage devices, such as, primary alkaline batteries, primary lithium batteries, nickel metal hydride batteries, sodium batteries, lithium sulfur batteries, lithium air batteries, and supercapacitors. Methods of making such devices are known in the art and are described, for example, in “Battery Reference Book”, by TR Crompton, Newness (2000).

The invention is further illustrated by the following non-limited examples.

### EXEMPLIFICATION

### Materials and Methods

The materials used for the solvent-free electrode process and formulation included Lithium nickel manganese cobalt oxide NCM622 (SNCM03006) from Targray; standard activated carbon of surface area of 1500 cm²/g, used as a reference. The fibrillizable binder was polytetrafluorethylene (PTFE). All CNT and CB specifications were obtained from Cabot Corporation. The physical properties of the CNTs and CBs employed in the following examples can be found in Tables 1 and 2 above, respectively.

Cathode compositions included electrode active material such as lithiated transition metal oxide (e.g., NCM622), conductive carbon (e.g., CNT, CB, etc.), and fibrillizable binder (e.g., PTFE).

Generally, cathode electrodes were prepared in several stages. In a first step (S1) the electrode components were combined and mixed under conditions suitable to fibrillate the binder (e.g., by high shear mixing). The second step (S2) involved passing the powder blend from S1 through a vertical calender pre-set to the appropriate gap based on the desired film thickness. The free-standing films obtained from S2 were laminated onto a current collector in a third step (S3).

A similar sequence of steps was followed in preparing anode electrodes.

The thickness of the solvent-free electrodes was measured using a manual drop gauge with the flat gauging contact head of 7.14 mm diameter. A manual die cutter was used to punch discs of a diameter of 15 mm for cathode and 16 mm for anode.

Mechanical properties of free-standing dry films, for instance, tensile strength and Young's (elastic) modulus, were tested using Mecmesin MultiTest-dV motorized force tester with a 10N load. After the films were calendered to the desired thickness, they were cut into 70×20 mm strips using a die cut. Then, they were placed in the apparatus and the test program for the tensile test was performed.

The sheet resistance of the solvent-free electrodes was measured with a Signatone Pro4-4400 commercial system (SP4 probe head connected to the rear of a Keithley 2410-C source meter). The reported values were normalized by the electrode thickness and reported as electrode resistivity in Ohm·cm (Ω·cm).

### Example 1

In S1, electrode components were blended following a two-stage operation using a Resodyn acoustic mixer and an IKA mill. In more detail, the first stage of S1 was performed to prepare a uniform distribution of powder components in the blend and included a 10-minute pre-blending of a carbon additive and electrode active material in the acoustic mixer at 90% intensity and auto frequency, followed by the addition of the polymer and blending at the same settings for 20 more minutes.

The second stage involving fibrillating the blend was further processed using IKA Tube Mill 100 for 15 sec at 25,000 rpm for 6 cycles and 3 min at 5000 rpm for 1 cycle.

In S2, the powder blend obtained in S1 was passed through a vertical calender at 100° C. to obtain free-standing films having a thickness between 30 and 130 μm.

In S3, these free-standing electrode films were then laminated on the carbon-coated, 17-μm thick Al foil by calendering them together through a vertical calender at 100° C. to obtain the electrode.

The carbon additives shown in Table 1 and 2 were used to prepare cathode films according to the formulations shown in Table 3. All electrodes were prepared by a dry process and contained the carbon additive at a loading of 2 wt. %, NCM622 (94 wt. %) and PTFE (4 wt. %) at average thickness in the range of 107-110 μm.

TABLE 3

| | | | | Ave. Dry |
|---|---|---|---|---|
| | | | | Film |
| | Active | Carbon | | Thickness |
| Formulation ID | material | additive | Binder | (μm) |
| A1 | 94% NCM | 2% CNT1 | 4% PTFE | 107 |
| A2 | 94% NCM | 2% CNT2 | 4% PTFE | 107 |
| A3 | 94% NCM | 2% CNT3 | 4% PTFE | 107 |
| A4 | 94% NCM | 2% CNT4 | 4% PTFE | 109 |
| A5 | 94% NCM | 2% CB1 | 4% PTFE | 107 |
| A6 | 94% NCM | 2% AC | 4% PTFE | 110 |

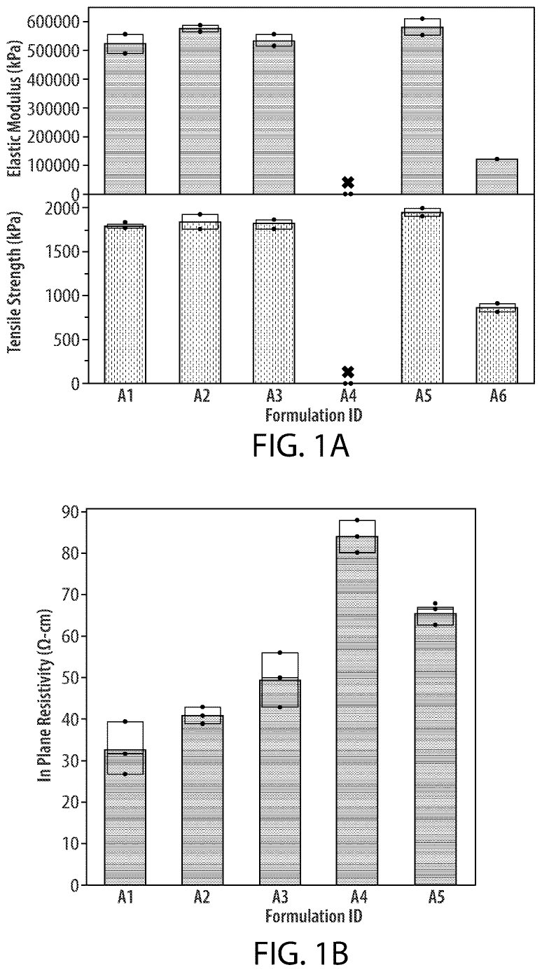

The compositions A1 through A6 in Table 3 were tested with respect to the mechanical properties of the free-standing dry-processed electrode films. In more detail, FIG. 1A compares the tensile strength and elastic modulus of the dry electrode films formulated using various CNTs, namely additives CNT1, CNT2, CNT3, and CNT4 (from Table 1), at an average film thickness of 107-109 μm. The films prepared with CB1 (from Table 2) and AC were used as references. The fibrillization capabilities of CNT1, CNT2, and CNT3 were comparable to CB1 and much better than the AC reference. CNT4 did not appear to fibrillize PTFE well. The electrode films made with CNT4 were brittle and rigid and could not be used for the tensile strength test. CNT1 provided the added benefit of lower electrode resistivity when tested at the same loading.

FIG. 1B compares the in-plane resistivity measured for dry cathodes with Formulation A1 through A5 (from Table 3). The electrode formulated with CNT1, CNT2, and CNT3 (from Table 1) showed improved in-plane resistivity compared to those prepared with CNT4 and a reference CB1. Furthermore, compared to other CNTs, CNT1 brought about the lowest electrode resistivity, a property advantageous for battery performance, for instance, rate capability, long-term cycling, etc.

### Example 2

The NCM electrode formulations B1 and B2 (Table 4) in this example were prepared by the procedure described in Example 1. The carbon additives employed were CNT5 and CNT1 (from Table 1). CNT5 was a pre-milled (pulverized) version of CNT1. The pulverization were carried out using a mechanical grinding machine (Model: FW177, from Tianjing Tai Si Te Instrument Co., Ltd.) at a frequency of 50 HZ, power of 1200 W, and speed of 24000 rpm/min, for 80 seconds of milling. The particle size distribution was measured by laser particle sizer (Model: Topsizer, Zhuhai OMEC Instruments Co., Ltd.). The particle size distribution for pristine CNT, namely CNT1, and its pulverized version, namely CNT5, used in this example, are summarized in Table 1.

The electrode formulations employed (labeled B1 and B2), are listed in Table 4, below. All dry electrode films were prepared by a dry process and contained the carbon additive at a loading of 2 wt. %, NCM622 (94 wt. %) and PTFE (4 wt. %) at thickness in the range of at 112±1.5 μm.

TABLE 4

| | | | | Ave. Dry |
|---|---|---|---|---|
| | | | | Film |
| | Active | Carbon | | Thickness |
| Formulation ID | material | additive | Binder | (μm) |
| B1 | 94% NCM | 2% CNT5 | 4% PTFE | 112 |
| B2 | 94% NCM | 2% CNT1 | 4% PTFE | 112 |

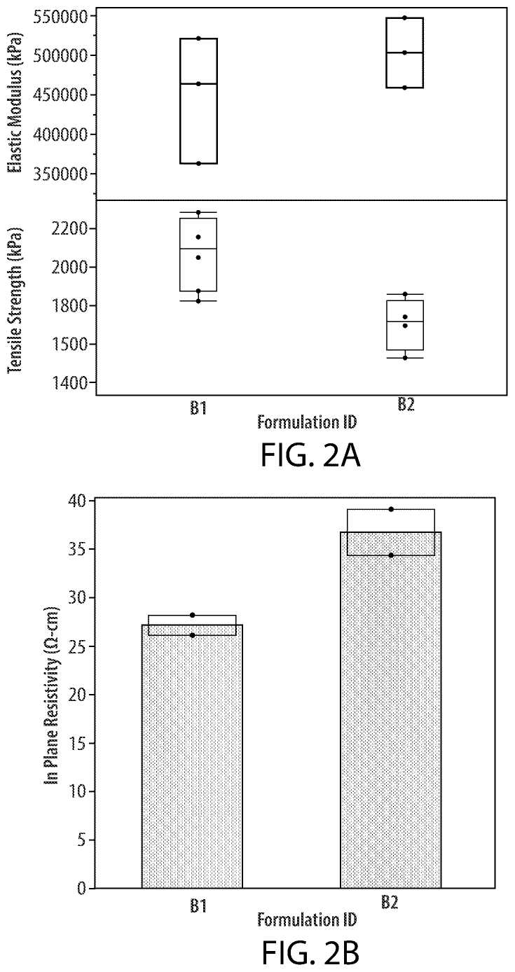

The tensile strength and elastic modulus of the dry cathode films and the electrode resistivity measured with formulation B1 with pulverized CNT5 (D₅₀~15 μm) and with formulation B2 with non-pulverized CNT1 (D₅₀~140 μm) are presented, respectively, in FIGS. 2A and 2B.

As seen in FIG. 2A, the tensile strength of the film electrode prepared with Formulation B1, with pulverized CNT5 (D₅₀~15 μm), showed an improvement (by ~30%) relative to the tensile strength of the electrode film prepared with formulation B2, with the non-pulverized CNT1 (D₅₀~140 μm). The elastic modulus of films made with the pulverized CNT5 was lower than that of the CNT1 film. The results indicate that the smaller particle size may be important to making film stronger and more flexible.

As seen in FIG. 2B, the electrode with pulverized CNT5 also led to improved conductivity of the electrode, which might be another indicator of a benefit of the selected particle size of CNTs (believed to lead to improved distribution of CNT particles throughout the electrode in addition to enhanced interactions with binder and fibrillization properties). An improvement in electrode resistivity (in other words, electrode conductivity) would benefit battery performance.

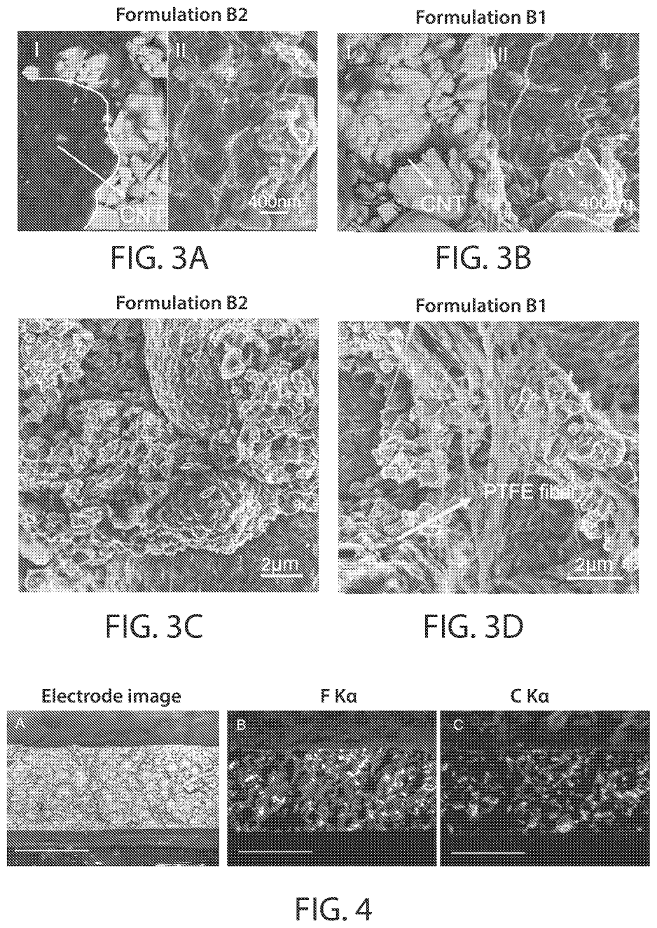

SEM photographs (second electron and backscattering electron image) and fluorine element mapping of cross-sections of electrode films with Formulation B1 and B2 are presented in FIG. 3. The left images of FIGS. 3A and 3B are backscattering electron images (A-I and B-I), and the right images are second electron images (A-II and B-II). Compared with the non-pulverized CNT, namely CNT1 (from Table 1), the dispersity of the pulverized CNT, namely CNT5 (from Table 1) was higher. Also, no significant aggregation was observed for films prepared with pulverized CNT5. This was in contrast to the aggregation seen in the red circle in the image of non-pulverized CNT1.

SEM analysis also provided some useful insights into the binder fibrillization level and how it was affected by the CNT PSD. As seen in FIGS. 3C and 3D, fibrils appeared to be wrapping around active electrode materials and/or carbon. Importantly, the quantity of PTFE fibrils seen in FIG. 3D with the pulverized CNT5 was noticeably higher than that observed with non-pulverized CNT1 (with the similar size scare bar). This may be indicative of improved binder fibrillization and appears to align well with the tensile strength data.

FIG. 4 shows EDS elemental mapping (scale bar: 100 μm) of fluorine, F, (image B) and carbon, C, (images C) of dry cathode film B1 made with the pulverized CNT5. The data confirmed the uniform distribution of carbon additive and polymer across the electrode. No binder migration phenomenon was detected (as is very often the case for slurry-prepared electrodes).

### Example 3

The NCM electrodes in this example were prepared by the same method as in Example 1. The loading of the carbon additive was 1 wt. %, the NCM amount was 96 wt. % and the PTFE loading was 3 wt. %. The average dry film thickness was 110±2 μm. The formulations employed to prepare electrode films are shown in Table 5.

TABLE 5

| | | | | Ave. Dry |
|---|---|---|---|---|
| | | | | Film |
| | Active | Carbon | | Thickness |
| Formulation ID | material | additive | Binder | (μm) |
| C1 | 96% NCM | 1% CNT5 | 3% PTFE | 110 |
| C2 | 96% NCM | 1% CNT1 | 3% PTFE | 110 |

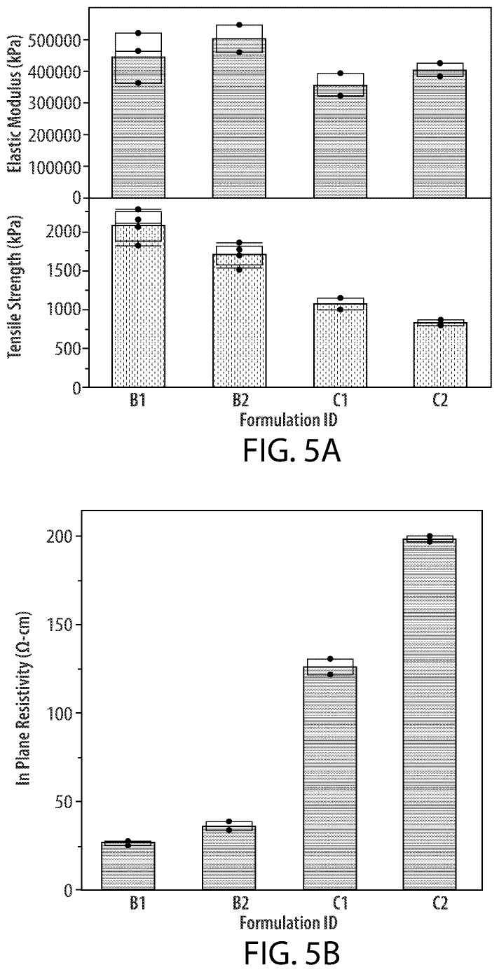

FIG. 5A compares the tensile strength and elastic modulus for 2 sets of dry electrode films, namely B1 and B2 (from Table 4) and C1 and C2 (from Table 5), prepared with pulverized and non-pulverized CNTs, namely CNT5 and CNT1 (from Table 1), at the two different NCM/CNTs/PTFE formulations, namely 94/2/4 and 96/1/3, respectively. The in-plane resistivity comparison for the selected formulations is presented in FIG. 5B. Relative to the 94/2/4 films, the tensile strength and the elastic modulus both decreased with films prepared with the 96/1/3 formulations of Table 5 (which contained less CNTs, less binder and increased amounts of the active material). In-plane resistivity was higher for the lower CNTs loading.

Pulverized CNTs at both CNTs loadings displayed an increase in tensile strength relative to non-pulverized CNTs. A drop in elastic modulus was observed when using pulverized (versus non-pulverized) CNTs for both the 96/1/3 and 94/2/4 formulations implying improved flexibility of the free-standing films. Compared to non-pulverized CNTs, pulverized CNTs reduced the in-plane resistivity of the electrode prepared with both the 96/1/3 and 94/2/4 formulations, thus benefiting the battery electrochemical performance.

### Example 4

The NCM electrodes in this example were prepared following the procedure described in Example 1. The CNT5, CNT6, CNT7, and CNT9 employed in this example were pre-milled version of CNT1, CNT2, CNT3, and CNT4 (from Table 1), processed by the same milling method as described in Example 2 to reach D50 of 15 μm.

Four kinds of pristine CNTs were milled to obtain the same D₅₀. The electrode formulations employed (labeled D1 through D4) are listed in Table 6, below. All electrodes contained CNTs at a loading of 1 wt. %, NCM at a loading of 96 wt. %, and PTFE at a loading of 3 wt. %, with the average dry film thickness at 75±2 μm. The dry electrode film D4 was too brittle and did not enable fabrication of free-standing film, which indicated CNT5, 6, 7 with higher surface area and smaller average diameter have better ability to assist as processing aid than CNT9 with lower surface area (<150 m²/g) and bigger diameter (>30 nm).

TABLE 6

| | | | | Aver. Dry |
|---|---|---|---|---|
| | | | | Film |
| | Active | Carbon | | Thickness |
| Formulation ID | material | additive | Binder | (μm) |
| D1 | 96% NCM | 1% CNT5 | 3% PTFE | 75 |
| D2 | 96% NCM | 1% CNT6 | 3% PTFE | 75 |
| D3 | 96% NCM | 1% CNT7 | 3% PTFE | 75 |
| D4 | 96% NCM | 1% CNT9 | 3% PTFE | N/A |

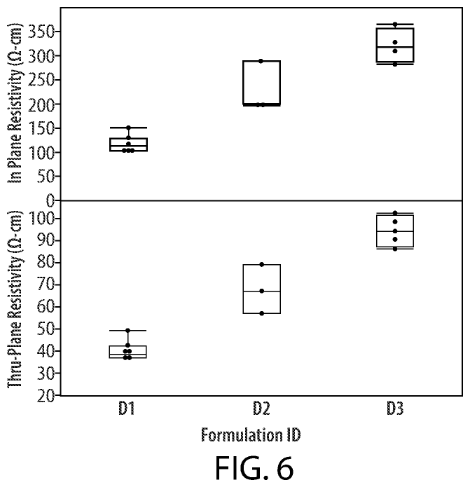

FIG. 6 compares the in-plane and through-plane resistivity of dry electrodes for formulation D1, D2, D3. As seen in this figure, the formulation D1, made with CNT5, featured the lowest resistivity.

### Example 5

Cathode dry-processed free-standing films and test electrodes were prepared by the same method as in Example 1.

The electrode formulations employed (labeled E1 through E7) are listed in Table 7, below. All the electrode films were prepared with a carbon additive (CB only, CNT only, or combinations of CB and CNT, blended at different CB/CNT ratios) at a total carbon loading of 2 wt %. The NCM loading was 94 wt. % and the PTFE loading was 4 wt. %.

TABLE 7

| | | | | | Aver. |
|---|---|---|---|---|---|
| | | | | | Dry |
| | | | | | Film |
| Formulation | Active | Carbon | CB/CNT | | Thickness |
| ID | material | additive | ratio | Binder | (μm) |
| E1 | 94% NCM | 2% CNT8 | 0:100 | 4% PTFE | 108 |
| E2 | 94% NCM | 2% CB1/ | 40:60 | 4% PTFE | 110 |
| | | CNT8 | | | |
| E3 | 94% NCM | 2% CB1/ | 80:20 | 4% PTFE | 110 |
| | | CNT8 | | | |
| E4 | 94% NCM | 2% CB1 | 100:0 | 4% PTFE | 113 |
| E5 | 94% NCM | 2% CB2/ | 40:60 | 4% PTFE | 114 |
| | | CNT8 | | | |
| E6 | 94% NCM | 2% CB2/ | 80:20 | 4% PTFE | 110 |
| | | CNT8 | | | |
| E7 | 94% NCM | 2% CB2 | 100:0 | 4% PTFE | 108 |

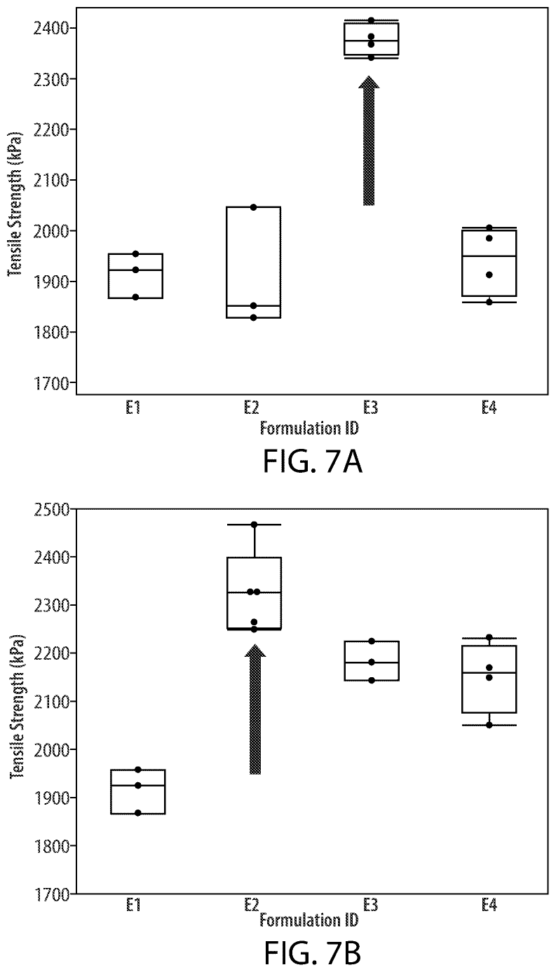

FIG. 7A compares the tensile strength of electrode dry film with formulation E1 (an NCM electrode film containing CNT8 only) with dry electrode films with formulation E2 and E3 (formulated with CB/CNT blended at two different ratios), and dry electrode films with formulation E4 (containing CB1 only). As seen in FIG. 7A, dry electrodes film prepared with CB/CNT blends for E3 showed improved tensile strength as compared to formulations E1 and E4 containing CNT and CB as a single carbon additive, respectively. This might be ascribed to a synergistic effect. A synergistic effect was also observed for CB2/CNT8, as seen in FIG. 7B, but appeared at a different CB/CNT ratio (refer to E5 from Table 7), which might be affected by a difference in surface area between CB1 and CB2.

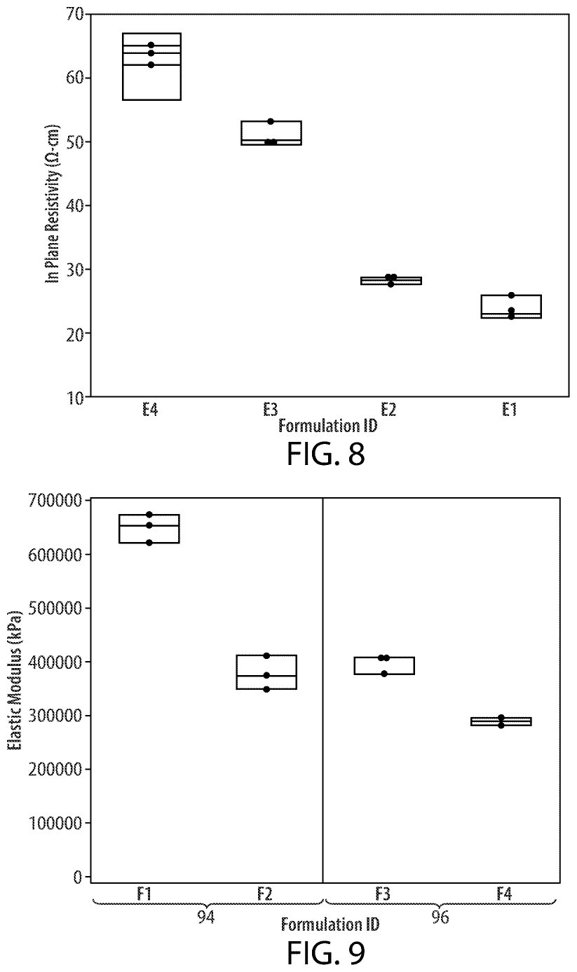

As shown in FIG. 8, electrodes prepared using CB1/CNT8 blends also displayed lower electrode resistivity relative to the pure CB-containing electrode, an effect advantageous for battery performance.

### Example 6

Selected cathode formulations and test electrodes were prepared following the method described in Example 1.

Two sets of electrode films were prepared with a CB only, namely CB3, and combinations of CB and CNT, namely CB3 and CNT5 (from Table 2 and Table 1, respectively) blended at 80:20 ratio, targeting the dry film thickness of 110 μm upon calendering.

Table 8 shows amounts of carbon additive (1 and 2 wt. %) and amounts of PTFE (1, 2, and 3 wt. %) employed to make free-standing electrode films, which were evaluated for film processibility; NCM representing the balance to 100 wt. %. In Table 8, “pass” indicates that a continuous and flexible film could be formed; “fail” indicates that no continuous and flexible film could be formed.

TABLE 8

| Formulation | 4% PTFE | 3% PTFE | 2% PTFE |
|---|---|---|---|
| 2% CB3/CNT5 (80:20) | Pass | Pass | Fail |
| 1% CB3/CNT5 (80:20) | Pass | Pass | Fail |
| 2% CB3 | Pass | Fail | Fail |
| 1% CB3 | Pass | Pass | Fail |

At 2 wt % of total carbon additive, both formulations containing a CB/CNT blend and a CB only, in combination with PTFE loaded at 4 wt. %, delivered good quality, free-standing films. Moving toward lower content of electrochemically inactive materials, for instance, 3 wt. % of PTFE, the presence of CB3/CNT5 blend led to the formation of strong and flexible cathode films, while a film with CB3 alone did not result in a continuous and flexible film formation at the given conditions (labeled as “fail” in Table 9).

At 1 wt % of carbon additive loading, films could be made with both CB3 alone and a CB3/CNT5 blend. However, the blend made the film more flexible as indicated by the elastic modulus data in FIG. 9. (The selected electrode formulations which made possible the formation of a good quality film (labeled F1 through F4) are listed in Table 9, below.)

TABLE 9

| | | | | | Aver. |
|---|---|---|---|---|---|
| | | | | | Dry |
| | | | | | Film |
| Formulation | Active | Carbon | CB/CNT | | Thickness |
| ID | material | additive | ratio | Binder | (μm) |
| F1 | 94% NCM | 2% CB3 | 100:0 | 4% PTFE | 110 |
| F2 | 94% NCM | 2% CB3/ | 80:20 | 4% PTFE | 110 |
| | | CNT5 | | | |
| F3 | 96% NCM | 1% CB3 | 100:0 | 3% PTFE | 110 |
| F4 | 96% NCM | 1% CB3/ | 80:20 | 3% PTFE | 110 |
| | | CNT5 | | | |

FIG. 9 compares the elastic modulus of NCM dry electrode films containing CB3 only with those containing CB3/CNT5 blends. As seen in FIG. 9, electrode films prepared by a dry process that employed CB/CNT blends (refer to F2 and F4 in Table 9) showed improvement in the elasticity of the film compared to the counterpart CB only formulations (refer to F1 and F3 in Table 9) when compared at the same NCM-Carbon-PTFE loadings.

### Example 7

Cathode formulations and test electrodes were prepared according to the method in Example 1.

The electrode formulations employed (labeled G1 through G6, and A6 serving as an AC-containing reference) are listed in Table 10, below. All electrodes were prepared with a carbon additive that was CB only, CNT only, or combinations of CB and CNT (CB/CNT) blended at different ratios, at a loading of 2 wt. %, NCM at 94 wt % and PTFE at 4 wt. %. The average dry film thickness was at 110±1.5 μm.

TABLE 10

| | | | | | Aver. |
|---|---|---|---|---|---|
| | | | | | Dry |
| | | | | | Film |
| Formulation | Active | Carbon | CB/CNT | | Thickness |
| ID | material | additive | ratio | Binder | (μm) |
| G1 | 94% NCM | 2% CB4 | 100:0 | 4% PTFE | N/A |
| G2 | 94% NCM | 2% CB4/ | 80:20 | 4% PTFE | N/A |
| | | CNT8 | | | |
| G3 | 94% NCM | 2% CB4/ | 70:30 | 4% PTFE | N/A |
| | | CNT8 | | | |
| G4 | 94% NCM | 2% CB4/ | 40:60 | 4% PTFE | 108 |
| | | CNT8 | | | |
| G5 | 94% NCM | 2% CNT8 | 0:100 | 4% PTFE | 112 |
| G6 | 94% NCM | 2% CB4/ | 40:60 | 4% PTFE | 111 |
| | | CNT5 | | | |
| A6 | 94% NCM | 2% AC | N/A | 4% PTFE | 110 |

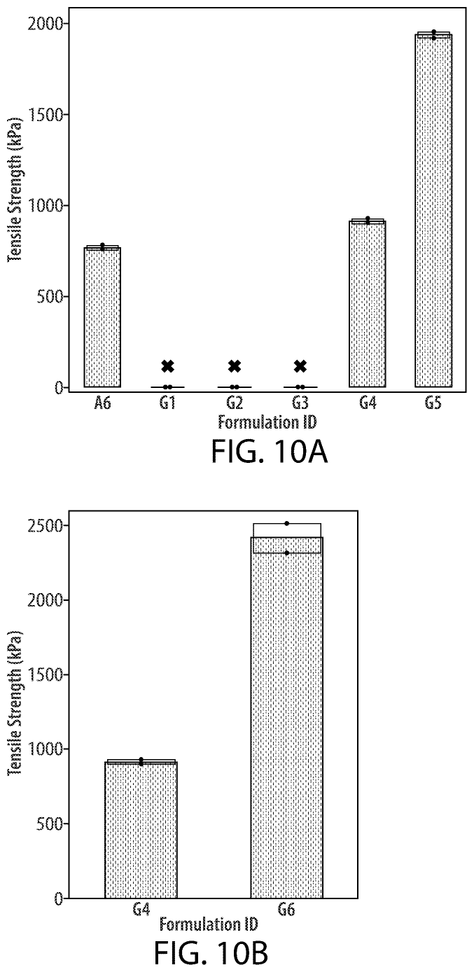

It was found that no continues and flexible dry-processed NCM electrode film could be made with CBs having a low surface area (SA), for instance, CB4, when used as a single conductive additive or blended with CNT, namely CNT8, at a CB/CNT ratio higher than 50:50 (refer to formulations G1, G2, and G3 in Table 10). Blending CB4 and CNT8 at ratios that are lower than 50:50, for instance 40:60 (refer to formulation G4), however, improved processibility and enabled the formation of a continues and flexible free-standing film, as shown in FIG. 10A. (Cross marks represent no good film formation.)

Utilizing CNT5 in the blend, rather than CNT8, could further improve the processibility by boosting the tensile strength of the electrode film, as evidenced by the comparison of the selected formulation G4 and G6 containing low SA CB4/CNT8 and CB4/CNT5 at the same 40:60 ratio and 2 wt. % of total carbon loading (FIG. 10B).

### Example 8

The graphite electrode formulations H1 through H₄ (Table 11) in this example were prepared by the procedure described in Example 1. The carbon additives employed were CNT1, CNT3, and CNT4 (from Table 1) and an AC used for reference. All CNT-containing dry electrode films were prepared by a dry process and contained the carbon additive at a loading of 1 wt. %, NCM622 (94 wt. %) and PTFE (5 wt. %).

TABLE 11

| | Active | Carbon | |
|---|---|---|---|
| Formulation ID | material | additive | Binder |
| H1 | 94% Graphite | 1% CNT1 | 5% PTFE |
| H2 | 94% Graphite | 1% CNT3 | 5% PTFE |
| H3 | 94% Graphite | 1% CNT4 | 5% PTFE |
| H4 | 90% Graphite | 5% AC | 5% PTFE |

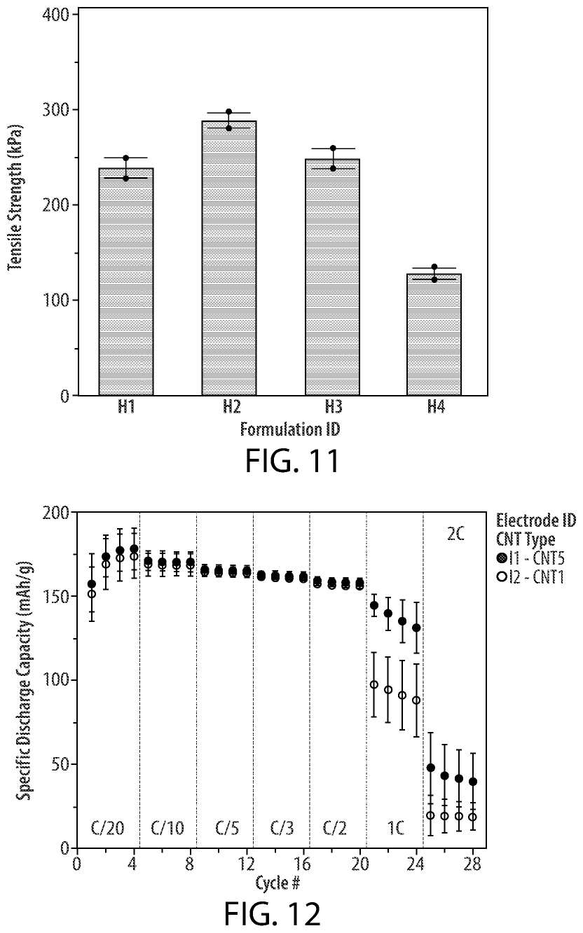

As seen in FIG. 11, formulations with CNT1, CNT3, and CNT4 showed an improvement (80% at least) relative to the tensile strength of the reference anode film prepared with AC when at the same binder loading of 5 wt. %.

### Example 9

A series of dry cathodes (labeled I1 through I5) were prepared by the same processes as in Example 1. The electrode formulations employed, and characteristics of the resulting cathodes are listed in Table 12 below. All dry cathodes contained NCM622 (96 wt. %), binder (3 wt. %), and 1 wt. % CNT of selected type (refer to Table 1 for details).

TABLE 12

| | | Active | | |
|---|---|---|---|---|
| | | material | Electrode | Electrode |
| Electrode | | loading | density | Capacity |
| ID | Formulation | [mg/cm²] | [g/cm³] | [mAh/cm²] |
| I1 | 96% NCM, 1% | 24.6 | 3.8 | 4.2 |
| | CNT5, 3% PTFE | | | |
| I2 | 96% NCM, 1% | 25.7 | 3.6 | 4.4 |
| | CNT1, 3% PTFE | | | |
| I3 | 96% NCM, 1% | 26.0 | 3.6 | 4.4 |
| | CNT6, 3% PTFE | | | |
| I4 | 96% NCM, 1% | 25.4 | 3.6 | 4.3 |
| | CNT7, 3% PTFE | | | |
| I5 | 96% NCM, 1% | 15.4 | 4.1 | 2.6 |
| | CNT5, 3% PTFE | | | |

The cathodes from Table 12 were tested in 2032 full coin cells. Fifteen-millimeter in diameter discs were punched for coin-cell preparation and dried at 100° C. under vacuum for a minimum of 4 hours. Discs were calendered at the desired electrode density with a manual roll press and assembled into 2032 coin-cells in an argon-filled glove box (M-Braun) for testing against slurry-processed graphite anodes which contained 3% CB, 5% PVDF, 92% natural graphite, at anodic access of 1.2, measured as a negative to positive electrodes capacity ratio (N/P). 2325 Celgard film were used as separators. The IM Lithium hexafluorophosphate (LiPF6) in ethylene carbonate-dimethyl carbonate-ethyl methyl carbonate (EC-DMC-EMC, 1:1:1 by wt.) with 1 wt. % vinylene carbonate (VC) from BASF was used as electrolyte. Room temperature (25° C.) rate performance of the full coin cells was measured by first forming them by four C/20-D/20 charge-discharge cycles, then charging and discharging them at each rate for four cycles at C/10, C/5, C/3, C/2, 1C, and 2C, respectively. Reported capacities are normalized in mAh/g of active cathode mass. Cycling performance testing was carried out at 25° C. using C/3 charge and C/3 discharge rate.

FIG. 12 shows C-rate performance data for cathodes I1 and I2 prepared with CNTs of the same type and diameter range but different average agglomerate size. The dry-processed cathode 12 made with standard CNT1 of D₅₀=135 μm had comparable capacity at C-rates up to C/3 (C/20, C/10, C/5, C/3), but worse discharge capacity at higher C rate (C/2 and above), compared to the dry cathode I1 made with CNT5 of D₅₀=15 μm, which indicates rate capability performance benefit of the latter being driven by smaller agglomerate size and improved CNT distribution in the electrode.

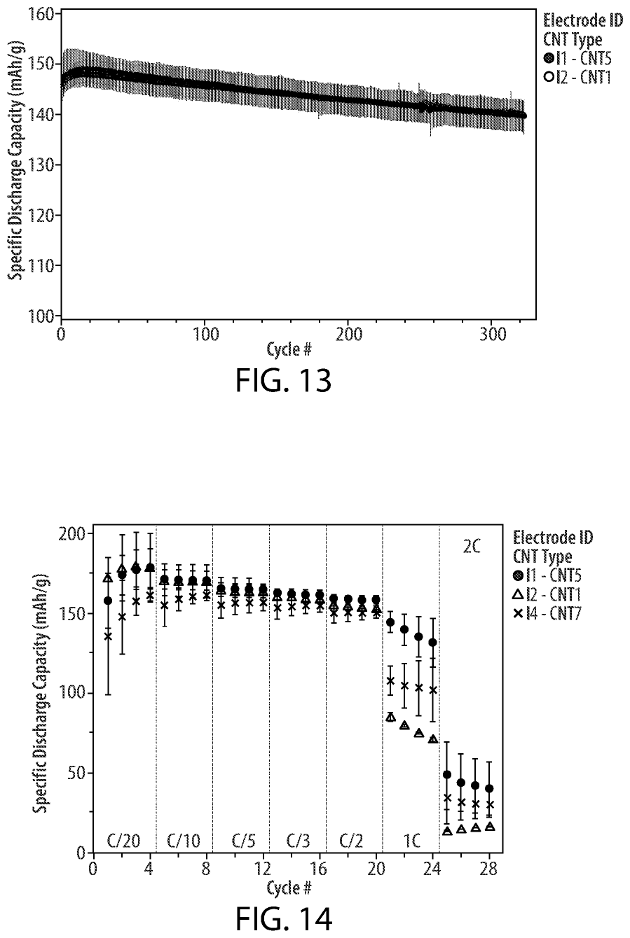

Cycling performance testing of the same two cathodes (I1 and I2) is shown in FIG. 13. They showed very similar specific discharge capacity, retaining over 95% of the initial capacity over 300 cycles. This indicates that the smaller size CNT5 provides the same benefit of stable cycling performance as standard CNT1 grade.

### Example 10

FIG. 14 shows C-rate capability of the cells prepared with I1, I3, and I4 cathodes from Table 12, comparing performance of CNTs of different type and diameter range but same average agglomerate size (CNT 5, CNT6, and CNT7, respectively; D₅₀=15 μm). See Table 1. Formulation I1 with CNT5 consistently outperformed other CNTs showing superior rate capability. Cathodes with CNT5 and CNT6 also delivered higher capacity than the one with CNT7 at the C-rates up to C/2, suggesting that CNT of higher surface area (>230 m²/g) and smaller average diameter (<12 nm) outperform those of relatively lower surface area and bigger diameter.

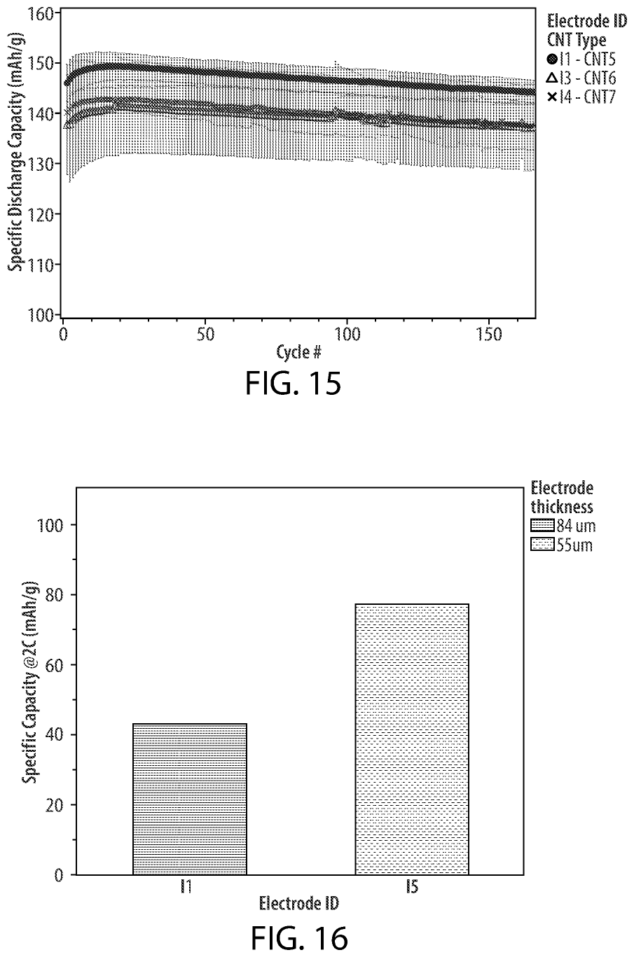

Furthermore, as seen in FIG. 15, during the long-term cycling carried out at 25° C. using C/3 charge and C/3 discharge rate, CNT5 (formulation I1) outperformed CNT6 and CNT7 (formulations I3 and I4, respectively) showing significantly higher discharge capacity, likely due to the combination of robust mechanical properties of the dry cathode film and improved electronic network provided by well-distributed and interconnected CNT5.

### Example 11

Use of CNTs of relatively low D₅₀ enabled fabrication of thinner cathodes with lower active material loading. The example of a thin cathode is listed in Table 12 under Electrode ID 15, containing 1 wt. % of CNT5, measured at thickness of single-side coated electrode of 55 μm and active material loading of 15.4 mg/cm².

FIG. 16 compares 2C discharge capacity of the two electrodes (ID #11 and ID #15), both made with 1 wt. % CNT5, but rolled at different thicknesses and, hence, measured with different active material loading and electrode density, as listed in Table 12. As seen in FIG. 16, the 55 μm-thick single-side coated dry cathode 15 with lower active mass loading and higher density showed better 2C discharge capacity, doubling the value compared with thicker and less dense dry electrode I1.

### Example 12

Three cathodes were prepared by the same dry processes and tested in 2032 full coin cells following the same cell assembly and testing protocols as for the dry cathodes 11-15 in Example 9. The electrode formulations employed, and characteristics of the resulting cathodes are listed in Table 13 below. All cathodes contained NCM622 (96 wt. %) and binder (3 wt. %), carbon additive at a loading of 1 wt. %, with CB3 alone or CB3/CNT5 blends with two different CB/CNT ratios. Cathode containing 1 wt. % CNT5 (refer to electrode I1 in Table 12) was used for comparison.

TABLE 13

| | | Active | | |
|---|---|---|---|---|
| | | material | Electrode | Electrode |
| Electrode | | loading | density | Capacity |
| ID | Formulation | [mg/cm²] | [g/cm³] | [mAh/cm²] |
| J1 | 96% NCM, 0.4% | 25.5 | 3.8 | 4.3 |
| | CB3/0.6% | | | |
| | CNT5, 3% PTFE | | | |
| J2 | 96% NCM, 0.8% | 26.0 | 3.7 | 4.4 |
| | CB3/0.2% | | | |
| | CNT5, 3% PTFE | | | |
| J3 | 96% NCM, 1% | 26.4 | 3.7 | 4.5 |
| | CB3, 3% PTFE | | | |

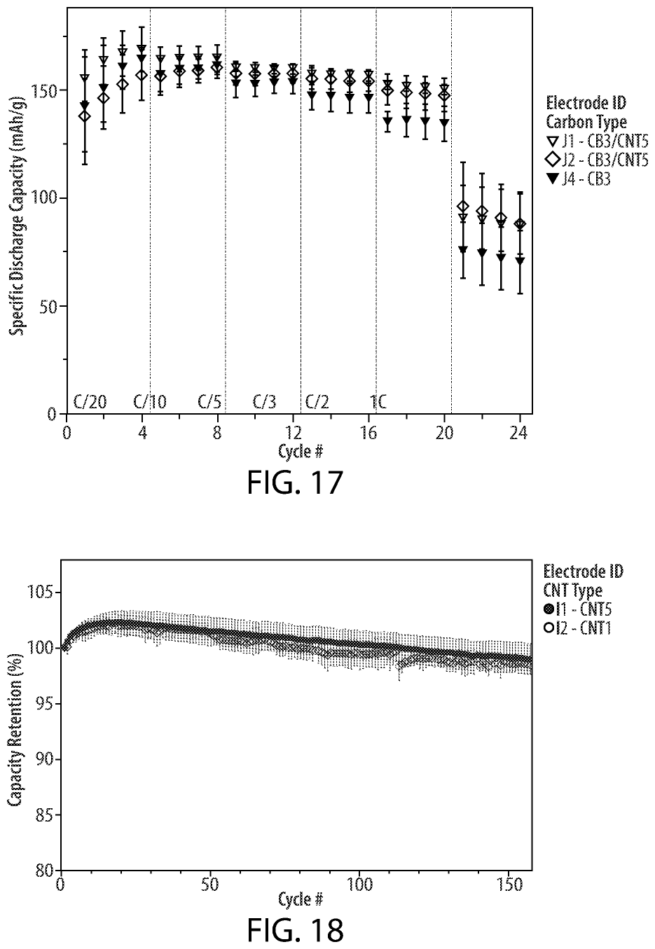

Two groups of cells for which cathode formulation contained CB/CNT blends (Electrode J1 and J2) showed improved discharge capacity compared to the cathode made with CB alone (electrode J3), as shown in FIG. 17.

Furthermore, cycle-life testing confirmed good cycling performance of the cathode with a CB/CNT blend (formulation J2, Table 13), maintaining capacity retention of 98% over 150 cycles, close to the one with CNT alone (electrode I1, Table 12), indicating comparable structural and electrochemical stability of both dry cathodes (FIG. 18).

While this invention has been particularly shown and described with references to preferred embodiments thereof, it will be understood by those skilled in the art that various changes in form and details may be made therein without departing from the scope of the invention encompassed by the appended claims.

1. A method for preparing an electrode composition, the method comprising:
combining an active electrode material, a binder and carbon nanotubes; and
processing the binder in the presence of the carbon nanotubes,
wherein,
the method is conducted in the absence of solvent and the carbon nanotubes have a BET within a range of from about 80 to about 500 m²/g.

2. (canceled)

3. (canceled)

4. The method of claim 1, wherein the carbon nanotubes have a diameter within a range from about 2 to about 50 nanometers.

5. The method of claim 1, wherein the carbon nanotubes have an average particle size (D₅₀) within a range of from about 5 to about 500 microns as measured by laser diffraction analysis.

6. (canceled)

7. (canceled)

8. The method of claim 1, wherein the active electrode material is a lithium transition metal compound.

9. The method of claim 1, wherein the active electrode material is graphite, a silicon-containing compound, or any combination thereof.

10. The method of claim 1, wherein the carbon nanotubes are provided in an amount that is no greater than about 5% by weight based on the total weight of the electrode composition.

11. The method of claim 1, wherein the method is conducted in the presence of the carbon nanotubes as the only fibrillating agent.

12. The method of claim 1, wherein the carbon nanotubes are provided in combination with another fibrillating agent.

13. The method of claim 1, wherein the carbon nanotubes are provided in combination with a carbon black.

14.-22. (canceled)

23. The method of claim 13, wherein the method is conducted in the presence of the carbon nanotubes and of the carbon black as the only fibrillating agents.

24. The method of claim 13, wherein the method is conducted in the presence of the carbon nanotubes, the carbon black and at least one additional fibrillating agent.

25.-33. (canceled)

34. A solvent-free method for preparing an electrode composition, the method comprising:
combining an active electrode material, a fibrillizable binder and carbon nanotubes; and
subjecting the fibrillizable binder to a fibrillization operation in the presence of the carbon nanotubes, wherein:
the active electrode material, the fibrillizable binder, the carbon nanotubes and the electrode composition are loose particulate materials, and
the carbon nanotubes have a BET within a range of from about 80 to about 500 m²/g.

35. (canceled)

36. (canceled)

37. A method for preparing an electrode composition, the method comprising:
(a) subjecting a binder to high shear conditions in the presence of carbon nanotubes to process the binder; and
(b) adding an electrode active material before, during or after step (a), wherein,
the method is conducted without adding a solvent and the carbon nanotubes have a BET within a range of from about 80 to about 500 m²/g.

38. (canceled)

39. (canceled)

40. The method of claim 37, wherein the carbon nanotubes have a diameter within a range of from about 2 to about 50 nanometers.

41. The method of claim 37, wherein the carbon nanotubes have an average particle size (D₅₀) within a range of from about 5 to about 500 microns as measured by laser diffraction analysis.

42.-44. (canceled)

45. The method of claim 37, wherein the active electrode material is graphite, a silicon-containing compound, or any combination thereof.

46. The method of claim 37, wherein the carbon nanotubes are provided in an amount that is no greater than about 5% by weight based on the total weight of the electrode composition.

47. The method of claim 37, wherein the method is conducted in the presence of the carbon nanotubes as the only fibrillating agent.

48. The method of claim 37, wherein the carbon nanotubes are provided in combination with another fibrillating agent.

49. The method of claim 37, wherein the carbon nanotubes are provided in combination with a carbon black.

50.-58. (canceled)

59. The method of claim 49, wherein the method is conducted in the presence of the carbon nanotubes and of the carbon black as the only fibrillating agents.

60. The method of claim 49, wherein the method is conducted in the presence of the carbon nanotubes, the carbon black and at least one additional fibrillating agent.

61.-69. (canceled)

70. A dry processed film comprising: an active electrode material, a processed binder and carbon nanotubes, wherein before any drying operation, the film electrode contains solvent residue in an amount no greater than 1 wt % relative to the theoretical weight of the film electrode, wherein the carbon nanotubes have a BET within a range of from about 80 to about 500 m²/g.

71. The dry processed film of claim 70, wherein the dry processed film is free standing or laminated to a substrate.

72. (canceled)

73. (canceled)

74. The dry processed film of claim 70, wherein the carbon nanotubes have a diameter within a range of from about 2 to about 50 nanometers.

75. The dry processed film electrode of claim 70, wherein the carbon nanotubes have an average particle size (D₅₀) within a range of from about 5 to about 500 microns as measured by laser diffraction analysis.

76. (canceled)

77. (canceled)

78. The dry processed film of claim 70, wherein the active electrode material is a lithium transition metal compound.

79. The dry processed film of claim 70, wherein the active electrode material is graphite, a silicon-containing compound, or any combination thereof.

80. The dry processed film of claim 70, wherein the carbon nanotubes are present at a loading that is no greater than about 5 wt %.

81. The dry processed film of claim 70, wherein the carbon nanotubes are the only fibrillating agent.

82. The method of claim 70, wherein the carbon nanotubes are provided in combination with another fibrillating agent.

83. The dry processed film of claim 70, wherein the dry processed film further comprises carbon black.

84.-94. (canceled)

95. The dry processed film of claim 70, wherein the film is free-standing, has a tensile strength of at least about 0.1 MPa and a thickness within a range of from about 30 to about 500 microns.

96. An electrode comprising the dry processed film of claim 70.

97. The electrode of claim 96, wherein the dry processed film is applied to a substrate.

98. A battery comprising the electrode of claim 96.
